(19) United States
(12) Patent Application Publication
(10) Pub. No.: US 2025/0173026 A1
(43) Pub. Date: May 29, 2025

(54) AUGMENTED REALITY DEVICE CAPABLE OF DISPLAYING VIRTUAL KEYBOARD AND OPERATION METHOD THEREOF

(71) Applicant: SAMSUNG ELECTRONICS CO., LTD., Suwon-si (KR)

(72) Inventors: Wonwoo LEE, Suwon-si (KR); Jiwon JEONG, Suwon-si (KR); Deokho KIM, Suwon-si (KR); Gunill KIM, Suwon-si (KR)

(73) Assignee: SAMSUNG ELECTRONICS CO., LTD., Suwon-si (KR)

(21) Appl. No.: 19/037,037

(22) Filed: Jan. 24, 2025

Related U.S. Application Data
(63) Continuation of application No. PCT/KR2024/013914, filed on Sep. 2, 2024.

(30) Foreign Application Priority Data
Sep. 13, 2023 (KR) 10-2023-0122066

(51) Int. Cl. G06F 3/042; G06F 3/01; G06T 3/18; G06T 15/20

(52) U.S. Cl. CPC G06F 3/0426; G06F 3/011; G06T 3/18; G06T 15/205

(57) ABSTRACT

An augmented reality (AR) device is provided and is capable of adaptively determining a virtual keyboard and an area where the virtual keyboard is to be overlaid based on attribute information of a surrounding real world and profile information of a virtual keyboard, and an operation method of the AR device is provided. The AR device may detect, by scanning the surrounding real world, at least one area including a plane on which no objects are detected; determine a type of a virtual keyboard capable of being overlaid on the at least one area, based on at least one from among a shape, a size, and an input language of the virtual keyboard; and perform rendering such that the virtual keyboard, having the type, is overlaid and displayed on the at least one area

### CROSS-REFERENCE TO RELATED APPLICATIONS

This application a bypass continuation application of International Application No. PCT/KR2024/013914, filed on Sep. 12, 2024, which claims priority to Korean Application No. 10-2023-0122066, filed in the Korean Intellectual Property Office on Sep. 13, 2023, the disclosures of which are herein incorporated by reference in their entireties.

### BACKGROUND

### 1. Field

Embodiments of the present disclosure relate to an augmented reality (AR) device configured to overlay and display a virtual keyboard in a real world and an operation method of the AR device. More particularly, Embodiments of the present disclosure relate to an AR device configured to detect an optimal area for overlaying and displaying a virtual keyboard on a surrounding real world and render a virtual keyboard on the detected area, and an operation method of the AR device.

### 2. Brief Description of Background Art

AR is a technology whereby virtual objects are overlaid on a physical environment space of a real world or on real-world objects and shown together, and has the advantage of providing virtual objects and virtual information by fusing them in the real world. AR devices (e.g., smart glasses) using AR technology are efficiently used in everyday life such as for, for example, information search, route guidance, or image capture with a camera. In particular, smart glasses are worn as a fashion item and are mainly used for outdoor activities.

Unlike a typical PC using a physical keyboard or a mobile device using a keyboard composed of a graphical user interface (UI) displayed on a touch screen, AR devices may display a virtual keyboard by overlaying the virtual keyboard on a surrounding real world according to device characteristics, and provide input means through an interaction such as a user's hand gesture of touching the virtual keyboard. A virtual keyboard is a keyboard that is distinct from a physical keyboard, and refers to a virtual keyboard implemented through software.

When an AR device displays a virtual keyboard in the air, the speed of receiving a key input, such as a hand gesture, from a user is very slow, and when the AR device displays a virtual keyboard on a plane where the user's hand is located, a space having a size greater than or equal to a keyboard is necessary. Conventional AR devices display a virtual keyboard in an arbitrary area regardless of the conditions of the user's surrounding environment, but, when there is not enough empty space in an area where the user's hand is located, it is inconvenient to use the virtual keyboard. For example, when the virtual keyboard is overlaid and displayed on a flat surface on a desk with many objects placed on it, the visibility of the virtual keyboard is low, and the entire virtual keyboard is not displayed completely or is displayed in a reduced size, which may result in reduced user convenience.

### SUMMARY

According to an embodiment of the present disclosure, a method performed by an augmented reality (AR) device is provided. The method may include: detecting, by scanning a surrounding real world, at least one area including a plane on which no objects are detected; determining a type of a virtual keyboard capable of being overlaid on the at least one area, based on at least one from among a shape, a size, and an input language of the virtual keyboard; and performing rendering such that the virtual keyboard, having the type, is overlaid and displayed on the at least one area.

According to an embodiment of the present disclosure, an AR device may be provided and include: at least one camera; at least one sensor including at least one from among an infrared sensor, a depth camera, and a light detection and ranging (LiDAR) sensor; a memory storing one or more instructions; and at least one processor configured to execute the one or more instructions, wherein the one or more instructions are configured to, when executed by the at least one processor, cause the AR device to: detect, by scanning a surrounding real world by using at least one from among the at least one camera 110 and the at least one sensor, at least one area including a plane on which no objects are detected; determine a type of a virtual keyboard that is capable of being overlaid on the at least one area, based on at least one from among a shape, a size, and an input language of the virtual keyboard; and perform rendering such that the virtual keyboard, having the type, is overlaid and displayed on the at least one area.

According to an embodiment of the present disclosure, a computer program product is provided and may include a non-transitory computer-readable storage medium. The non-transitory computer-readable storage medium may include instructions that are configured to, when executed by at least one processor of an AR device, cause the AR device to: detect, by scanning a surrounding real world, at least one area including a plane on which no objects are detected; determine a type of a virtual keyboard that is capable of being overlaid on the at least one area, based on at least one from among a shape, a size, or an input language of the virtual keyboard; and perform rendering such that the virtual keyboard, having the type, is overlaid and displayed on the at least one area

### BRIEF DESCRIPTION OF DRAWINGS

Embodiments of the present disclosure may be readily understood by reference to the following detailed description and the accompanying drawings, in which reference numerals refer to structural elements.

FIG. 1 is a conceptual diagram illustrating an operation, performed by an augmented reality (AR) device according to an embodiment of the present disclosure, of displaying a virtual keyboard on the real world.

FIG. 2 is a flowchart of a method, performed by the AR device according to an embodiment of the present disclosure, of displaying a virtual keyboard on the real world.

FIG. 3 is a block diagram of elements of the AR device according to an embodiment of the present disclosure.

FIG. 4 is a block diagram illustrating data input and output between software modules stored in a memory and a camera, a sensor, and a display of the AR device according to an embodiment of the present disclosure.

FIG. 5 is a flowchart of a method, performed by the AR device, of detecting at least one area by scanning a surrounding real world, according to an embodiment of the present disclosure.

FIG. 6 is a flowchart of a method, performed by the AR device according to an embodiment of the present disclosure, of determining types of virtual keyboards capable of being overlaid on the at least one area and determining a virtual keyboard among the determined types and an area where the virtual keyboard is to be overlaid.

FIG. 7 is a flowchart of a method, performed by the AR device according to an embodiment of the present disclosure, of determining types of virtual keyboards capable of being overlaid on the at least one area and determining a virtual keyboard among the determined types and an area where the virtual keyboard is to be overlaid.

FIG. 8A is a diagram illustrating an AR device according to an embodiment of the present disclosure that overlays and displays a virtual keyboard of a QWERTY type on an area.

FIG. 8B is a diagram illustrating an AR device according to an embodiment of the present disclosure that overlays and displays a virtual keyboard of a Cheonjiin (Korean texting system) input method on an area.

FIG. 8C is a diagram illustrating an AR device according to an embodiment of the present disclosure that overlays and displays a virtual keyboard of a numeric key type on an area.

FIG. 8D is a diagram illustrating an AR device according to an embodiment of the present disclosure that overlays and displays a virtual keyboard of a 12-key English keypad input method on an area.

FIG. 9 is a diagram for explaining an operation, performed by an AR device, of overlaying and displaying a split type keyboard on a plurality of areas, according to an embodiment of the present disclosure.

FIG. 10 is a view illustrating an operation, performed by an AR device, of overlaying and displaying a virtual keyboard on a portion of a body part of a user, according to an embodiment of the present disclosure.

FIG. 11 is a view illustrating an operation, performed by an AR device, of tracking a movement of a body part of a user and displaying a virtual keyboard, according to an embodiment of the present disclosure.

FIG. 12 is a flowchart of a method, performed by an AR device, of changing the color of a virtual keyboard, based on color information of an area on which the virtual keyboard is overlaid, according to an embodiment of the present disclosure.

FIG. 13 is a flowchart of a method, performed by an AR device, of displaying a virtual keyboard on a determined area, based on a hand gesture of a user, according to an embodiment of the present disclosure.

FIG. 14 is a view illustrating an operation, performed by an AR device, of displaying a virtual keyboard on a determined area, based on a hand gesture of a user, according to an embodiment of the present disclosure.

FIG. 15 is a flowchart of a method, performed by an AR device, of determining a virtual keyboard and an area on which the virtual keyboard is to be displayed, based on context, according to an embodiment of the present disclosure.

FIG. 16 is a view illustrating an operation, performed by an AR device, of determining a virtual keyboard and an area on which the virtual keyboard is to be displayed, based on context, according to an embodiment of the present disclosure.

### DETAILED DESCRIPTION

Although general terms widely used at present were selected for describing non-limiting example embodiments of the present disclosure in consideration of the functions thereof, these general terms may vary according to intentions of one of ordinary skill in the art, case precedents, the advent of new technologies, or the like. Terms arbitrarily selected by the applicant of the present disclosure may also be used in a specific case. In this case, their meanings may be given in the detailed description of an embodiment of the present disclosure. Hence, the terms must be defined based on their meanings and the contents of the entire specification, not by simply stating the terms.

An expression used in the singular may encompass the expression of the plural, unless it has a clearly different meaning in the context. Unless otherwise defined, all terms (including technical and scientific terms) used herein have the same meaning as commonly understood by one of ordinary skill in the art to which this disclosure belongs.

The terms “comprises” and/or “comprising” or “includes” and/or “including” when used in this specification, specify the presence of stated elements, but do not preclude the presence or addition of one or more other elements. The terms “unit,” “-er (-or),” and “module” when used in this specification refer to a unit in which at least one function or operation is performed, and may be implemented as hardware, software, or a combination of hardware and software.

The expression “configured to (or set to)” used therein may be used interchangeably with, for example, “suitable for,” “having the capacity to,” “designed to,” “adapted to,” “made to,” or “capable of,” according to situations. The expression “configured to (or set to)” may not only refer to “specifically designed to” in terms of hardware. Instead, in some situations, the expression “system configured to” may refer to a situation in which the system is “capable of” together with another device or parts. For example, the phrase “a processor configured (or set) to perform A, B, and C” may mean a dedicated processor (such as an embedded processor) for performing a corresponding operation, or a generic-purpose processor (such as a central processing unit (CPU) or an application processor (AP)) that can perform a corresponding operation by executing one or more software programs stored in a memory.

When an element (e.g., a first element) is “coupled to” or “connected to” another element (e.g., a second element), the first element may be directly coupled to or connected to the second element, or, unless otherwise described, a third element may exist therebetween.

As used herein, “augmented reality (AR)” refers to a technology for displaying a virtual image on a physical environment space of the real world or displaying a real world object and a virtual image together.

As used herein, a “real world” refers to the space of a real world that a user sees through an AR device. According to an embodiment of the present disclosure, the real world may refer to an indoor space. Real world objects may be placed within the real world.

As used herein, an “AR device” is a device capable of implementing AR, and may be, for example, not only AR glasses which are worn on the face of a user but also a head mounted display (HMD) apparatus or AR helmet which is worn on the head of a user. However, embodiments of the present disclosure are not limited thereto, and the AR device may be any type of electronic device, such as a laptop computer, a desktop computer, an e-book terminal, a digital broadcast terminal, personal digital assistants (PDAs), a portable multimedia player (PMP), a navigation device, an MP3 player, a camcorder, an Internet protocol television (IPTV), a digital TV (DTV), or a wearable device.

According to an embodiment of the present disclosure, the electronic device may be an AR device. The “AR device” is a device capable of implementing AR, and may be implemented as, for example, AR glasses that a user wears on the face. However, embodiments of the present disclosure are not limited thereto, and the AR device may also be implemented as a head mounted display (HMD) or AR helmet that is worn on the user's head.

As used herein, a “virtual keyboard” is a keyboard that is distinct from a physical keyboard, and refers to a virtual keyboard implemented through software. The virtual keyboard may be a graphical user interface (UI) composed of pixels overlaid in the real world. According to an embodiment of the present disclosure, the AR device may overlay a virtual keyboard on a surrounding real world by rendering a virtual image constituting the virtual keyboard, generating light of the rendered virtual image, and projecting the light of the virtual image to a waveguide through an optical engine. The optical engine may include, for example, an image panel, an illumination optical system, and a projection optical system.

Non-limiting example embodiments of the present disclosure are described in detail herein with reference to the accompanying drawings so that this disclosure may be easily performed by one of ordinary skill in the art to which the present disclosure pertains. Embodiments of present disclosure may, however, be embodied in many different forms and should not be construed as being limited to the examples set forth herein.

Non-limiting example embodiments of the present disclosure now will be described more fully hereinafter with reference to the accompanying drawings.

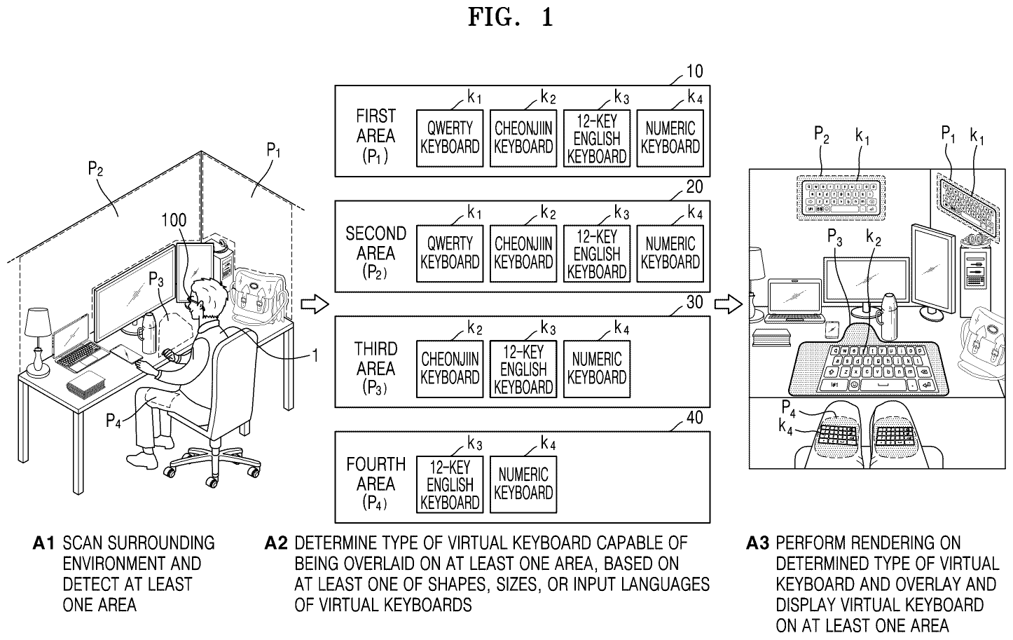

FIG. 1 is a conceptual diagram illustrating an operation, performed by an AR device 100 according to an embodiment of the present disclosure, of displaying a virtual keyboard on the real world.

The AR device 100 is a device capable of implementing AR and may be implemented as, for example, AR glasses that a user 1 wears on their face. The AR device 100 is illustrated as AR glasses in FIG. 1, but embodiments of the present disclosure are not limited thereto. As another example, the AR device 100 may be implemented as a head mounted display (HMD) or AR helmet worn on the head of the user 1.

Referring to FIG. 1, the AR device 100 scans a surrounding environment and detects at least one area (e.g., a first area P₁, a second area P₂, a third area P₃, and a fourth area P₄) (operation A1).

The AR device 100 determines the type of virtual keyboard capable of being overlaid on the at least one area (e.g., the first area P1, the second area P2, the third area P3, and the fourth area P4), based on at least one from among the shapes, sizes, and input languages of virtual keyboards (e.g., a first keyboard k₁, a second keyboard k₂, a third keyboard k₃, and a fourth keyboard k₄) (operation A2).

The AR device 100 may perform rendering on the determined types of virtual keyboards (e.g., the first keyboard k1, the second keyboard k2, the third keyboard k3, and the fourth keyboard k4) and overlay and display the virtual keyboards (e.g., the first keyboard k1, the second keyboard k2, the third keyboard k3, and the fourth keyboard k4) on the at least one area (e.g., the first area P1, the second area P2, the third area P3, and the fourth area P4) (operation A3).

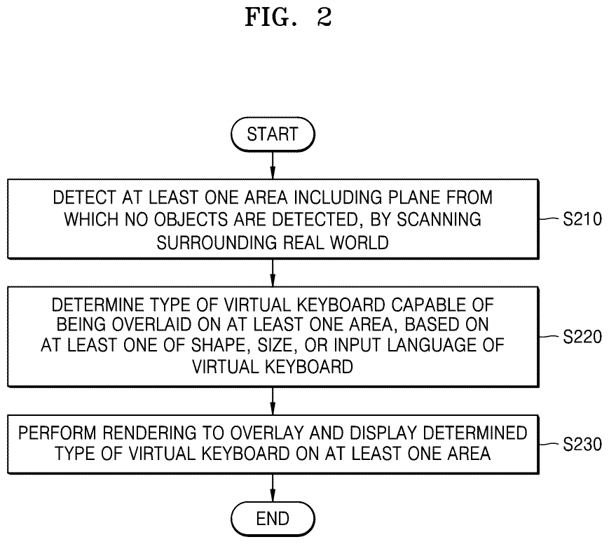

Hereinafter, a function and/or operation, performed by the AR device 100, of displaying a virtual keyboard in the real world will be described in detail with reference to FIGS. 1 and 2.

FIG. 2 is a flowchart of a method, performed by the AR device 100 according to an embodiment of the present disclosure, of displaying a virtual keyboard on the real world.

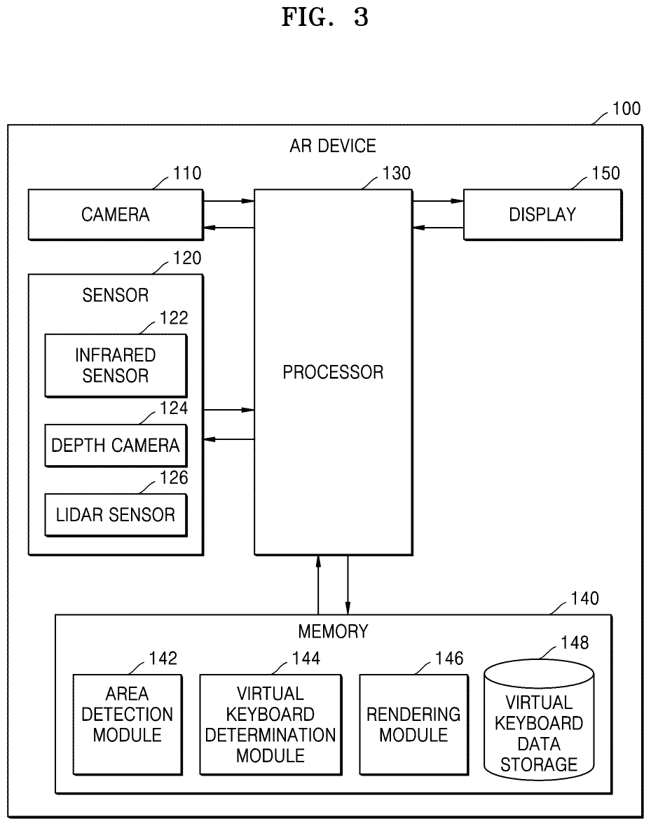

In operation S210, the AR device 100 detects at least one area including a plane on which no objects are detected, by scanning a surrounding real world. The AR device 100 may include a camera 110 (see FIG. 3), and may obtain image data of the real world by photographing the surrounding real world by using the camera 110. According to an embodiment of the present disclosure, the AR device 100 may include an infrared sensor 122 (see FIG. 3), a depth camera 124 (see FIG. 3), and/or a light detection and ranging (LIDAR) sensor 126 (see FIG. 3), and may obtain three-dimensional (3D) data about the real world by scanning the surrounding environment by using at least one from among the infrared sensor 122, the depth camera 124, and the LiDAR sensor 126. The 3D data may include data that explicitly expresses a 3D shape of the surrounding's real world such as, for example, a point cloud or mesh, or 3D data in an abstract form, such as a signed distance function.

The AR device 100 may detect, from the 3D data in the real world, at least one area including a plane in which no objects are detected, by performing plane detection. The AR device 100 may recognize a horizontal surface, such as a wall, floor, or desk surface in an office, by using a plane detection algorithm.

However, embodiments of the present disclosure are not limited thereto, and the AR device 100 according to an embodiment of the present disclosure may detect at least one area including a surface with a preset curvature from 3D data of the surrounding environment. For example, the AR device 100 may recognize a surface having a curvature similar to a cylinder.

According to an embodiment of the present disclosure, the AR device 100 may recognize an object placed on a plane or curved surface from the image data obtained through the camera, by performing vision recognition using an object recognition model composed of a trained artificial intelligence model. An “object” is a real world object placed on the real world, and may refer to, for example, a desk, chair, personal computer (PC), tablet PC, keyboard, mouse, or bag in an office. The AR device 100 may detect an area in which a real-world object is not detected from the detected plane or curved surface.

Referring to operation A1 of FIG. 1, the AR device 100 may obtain 3D data about the office by scanning the real world, and may detect, from the obtained 3D data, first, second, third, and fourth areas P₁, P₂, P₃, and P₄ where no objects are detected. In the embodiment shown in FIG. 1, the first area P₁ and the second area P₂ may be planes composed of the walls of the office, the third area P₃ may be an area on the surface of the desk where no objects are placed, and the fourth area P₄ may be the surface of a portion of a body part of the user 1. For example, the fourth area P₄ may be a surface with a predetermined curvature on the thigh among the user 1's body parts. The shapes of the first, second, third, and fourth areas P₁, P₂, P₃, and P₄ shown in FIG. 1, the sizes thereof, and the number (e.g., “four”) thereof are examples for convenience of explanation, and the shape, size, and number of “at least one area” of embodiments of the present disclosure are not limited to those shown in FIG. 1.

The AR device 100 may determine an area on which a virtual keyboard is unable to be overlaid from among the first, second, third, and fourth areas P₁, P₂, P₃, and P₄. According to an embodiment of the present disclosure, when a distance between the detected area and the user 1 exceeds a preset threshold, the AR device 100 may determine that the detected area is an area in which overlay of the virtual keyboard is impossible. The “area in which the overlap of the virtual keyboard is impossible” may include, for example, an area outside the range of approximately 60 to 80 centimeters, which is the arm length of a typical person. For example, the AR device 100 may determine that an area exceeding 80 centimeters is an area in which it is impossible to overlay a virtual keyboard, and may exclude the determined area from the at least one area (e.g., the first area P₁ through the fourth area P₄).

Referring back to FIG. 2, in operation S220, the AR device 100 determines the type of virtual keyboard capable of being overlaid on the at least one area, based on at least one from among a shape, size, and input language of the virtual keyboard. According to an embodiment of the present disclosure, the AR device 100 may obtain profile information of all types of virtual keyboards that may be provided. The profile information may include information about at least one from among the shape, size, and input language of the virtual keyboard. The profile information of the virtual keyboard may be previously stored in the memory 140 (see FIG. 3) of the AR device 100. The AR device 100 may obtain the profile information of the virtual keyboard by loading the profile information from the memory 140. However, embodiments of the present disclosure are not limited thereto. According to an embodiment of the present disclosure, the profile information of the virtual keyboard may be stored in a server or an external device, and the AR device 100 may perform data communication to obtain the profile information of the virtual keyboard from the server or the external device.

Among the profile information of the virtual keyboard, the “shape of the virtual keyboard” may include at least one from among, for example, a full-sized shape including all 106 keys, a split shape separable into multiple keyboard areas, a shape including only number keys, and a 12-key telephone keypad provided by a mobile device such as a cell phone. The “size of the virtual keyboard” may include information about a minimum displayable size and maximum displayable size at which the virtual keyboard is rendered. The “input language of the virtual keyboard” may include Korean, English, Chinese, Japanese, numbers, or special characters.

The AR device 100 may configure area-virtual keyboard combinations by matching the at least one area detected in operation S210 with all types of virtual keyboards that may be provided. Referring to operation of FIG. 1 together, the AR device 100 may configure a first area-virtual keyboard combination 10 by including a first keyboard k₁, which is a QWERTY-type virtual keyboard, a second keyboard k₂, which is a virtual keyboard of a Cheonjiin input method (a type of a Korean texting system), a third keyboard k₃, which is a virtual keyboard of a 12-key English keypad input method, and a fourth keyboard k₄, which is a virtual keyboard of a numeric input method, as types of virtual keyboards that may be matched to the first area P₁. Likewise, the AR device 100 may configure a second area-virtual keyboard combination 20 by matching the first keyboard k₁, the second keyboard k₂, the third keyboard k₃, and the fourth keyboard k₄ to the second area P₂, configure a third area-virtual keyboard combination 30 by matching the second keyboard k₂, the third keyboard k₃, and the fourth keyboard k₄ to the third area P₃, and configure a fourth area-virtual keyboard combination 40 by matching the third keyboard k₃ and the fourth keyboard k₄ to the fourth area P₄.

According to an embodiment of the present disclosure, the AR device 100 may match a plurality of virtual keyboards, that are capable of being overlaid, to each of the at least one area.

According to an embodiment of the present disclosure, the AR device 100 may split a virtual keyboard including a split type keyboard and match a result of the splitting with a plurality of areas.

The AR device 100 may evaluate the area-virtual keyboard combinations, based on area's attribute information including the size and shape of the at least one area and at least one from among the shape, size, and input language of virtual keyboards. According to an embodiment of the present disclosure, the AR device 100 may calculate evaluation scores about the area-virtual keyboard combinations by considering a distance between the at least one area and the user together with attribute information of the at least one area and the profile information including at least one from among the shape, size, and input language of virtual keyboards. Referring to the embodiment shown in FIG. 1, the AR device 100 may calculate an evaluation score of the first area-virtual keyboard combination 10, based on the size and shape of the first area P₁ and profile information about at least one from among the shape, size, and input language of each of the first through fourth keyboards k₁ through k₄. The AR device 100 may calculate evaluation scores for the second area-virtual keyboard combination 20, the third area-virtual keyboard combination 30, and the fourth area-virtual keyboard combination 40 in the above-described manner regarding the first area-virtual keyboard combination 10.

The AR device 100 may determine the type of virtual keyboard that may be overlaid on the at least one area, based on evaluation results regarding the area-virtual keyboard combinations. According to an embodiment of the present disclosure, the AR device 100 may determine that a virtual keyboard is capable of being overlaid on an area only for area-virtual keyboard combinations of which calculated evaluation scores exceed a preset reference score. Referring to the embodiment of FIG. 1, for example, the AR device 100 may determine that types of virtual keyboards capable of being overlaid on the first area P₁ include all of the first keyboard k₁, the second keyboard k₂, the third keyboard k₃, and the fourth keyboard k₄, based on the evaluation score for the first area-virtual keyboard combination 10. For example, the AR device 100 may determine that types of virtual keyboards that capable of being overlaid on the third area P₃ include the second keyboard k₂, the third keyboard k₃, and the fourth keyboard k₄, based on the evaluation score for the third area P₃. For example, the AR device 100 may determine that types of virtual keyboards that capable of being overlaid on the fourth area P₄ include the third keyboard k₃ and the fourth keyboard k₄, based on the evaluation score for the fourth area P₄. For example, when an evaluation score for an area is less than the reference score, the AR device 100 may determine that there is no virtual keyboard capable of being overlaid on the area.

Referring back to FIG. 2, in operation S230, the AR device 100 performs rendering to overlay and display the determined type of virtual keyboard on the at least one area. According to an embodiment of the present disclosure, the AR device 100 may perform rendering to enlarge or reduce the size of the virtual keyboard by scaling the virtual keyboard so that the virtual keyboard is suitable for the size and shape of the at least one area. Referring to operation A3 of FIG. 1, the AR device 100 may render the first keyboard k₁, which is a QWERTY type virtual keyboard, on the first area P₁ and the second area P₂, which have relatively large sizes. The AR device 100 may render the second keyboard k₂, which is a Cheonjiin type (a type of a Korean texting system) virtual keyboard, on the third area P₃, which is a relatively narrow area on the desk where no objects are placed. According to an embodiment of the present disclosure, the AR device 100 may render the second keyboard k₂, based on the size and shape of the third area P₃.

According to an embodiment of the present disclosure, when it is determined that the virtual keyboard is overlaid on the fourth area P₄, which is the surface of a portion (e.g., a thigh) of a body part of the user 1, the AR device 100 may perform rendering by warping the determined virtual keyboard (e.g., the fourth keyboard k₄, which is a numeric keyboard) based on the curvature of the surface of the body part.

According to an embodiment of the present disclosure, the AR device 100 determines a virtual keyboard and an area on which the virtual keyboard is to be overlaid, from a combination of at least one area and a type of virtual keyboard, based on at least one from among an input language, an input field, and usage history information. The AR device 100 may determine that a virtual keyboard included in a selected area-virtual keyboard combination is overlaid on a selected area. Referring to the embodiment of FIG. 1 together, the AR device 100 may select the third area-virtual keyboard combination 30 from the first, second, third, and fourth area-virtual keyboard combinations 10, 20, 30, and 40, based on at least one from among the input language, the input field, and the usage history information. The AR device 100 may determine the second keyboard k₂ constituting the third area-virtual keyboard combination 30, that is selected, as a virtual keyboard that is to be overlaid and displayed on the third area P₃.

The AR device 100 may overlay and display the rendered virtual keyboard on the determined area. According to an embodiment of the present disclosure, when the AR device 100 is implemented as AR glasses worn on the face of the user 1, the AR device 100 may include a display 150 (see FIG. 3) that is configured as a lens optical system and includes a waveguide and an optical engine. The AR device 100 may overlay and display a virtual keyboard on an area by generating, through the optical engine of the display 150, light of a graphic object composed of letters, numbers, special symbols, virtual images, or a combination thereof constituting the rendered virtual keyboard and projecting the light onto the waveguide.

AR devices of comparative embodiments display a virtual keyboard in an arbitrary area regardless of the attributes of the surrounding environment of the user. However, when there is not enough empty space in an area where the user's hand is located, it is inconvenient to use the virtual keyboard. For example, when the virtual keyboard is overlaid and displayed on a plane on a desk with many objects placed on it, the visibility of the virtual keyboard is low, such as the entire virtual keyboard is not displayed completely or the virtual keyboard is displayed in a reduced size, which may result in reduced availability of a virtual keyboard and reduced user convenience.

Embodiments of the present disclosure provide the AR device 100 that adaptively determines a virtual keyboard and an area where the virtual keyboard is to be overlaid, based on attribute information such as the size and shape of a real world around the user 1 and the size, shape, input language, etc., of a virtual keyboard, and an operation method of the AR device 100.

The AR device 100 according to the embodiment shown in FIGS. 1 and 2 adaptively determines an optimal area (e.g., the third area P₃ in the embodiment shown in FIG. 1) and an optimal virtual keyboard (e.g., the second keyboard k₂ in the embodiment shown in FIG. 1), based on the attribute information of the real world around the user 1 and at least one from among the shape, size, and input language of the virtual keyboard, thereby improving the visibility of the virtual keyboard and improving the usability and manipulation convenience of the virtual keyboard.

FIG. 3 is a block diagram of elements of the AR device 100 according to an embodiment of the present disclosure.

Referring to FIG. 3, the AR device 100 may include a camera 110, a sensor 120, a processor 130, a memory 140, and a display 150. The camera 110, the sensor 120, the processor 130, the memory 140, and the display 150 may be electrically and/or physically connected to each other. In FIG. 3, example elements for describing an operation of the AR device 100 are illustrated. The elements included in the AR device 100 are not limited to the elements illustrated in FIG. 3. According to an embodiment of the present disclosure, the AR device 100 may further include a communication interface for performing data communication with an external device or a server. In an embodiment of the present disclosure, the AR device 100 may be implemented as a portable device and, in this case, the AR device 100 may further include a battery to supply driving power to the camera 110, the sensor 120, the processor 130, and the display 150.

The camera 110 is configured to photograph a real world around a user and obtain images of the real world. The camera 110 may include a lens module, an image sensor, and an image processing module. The camera 110 may obtain a still image or a video of an object by using the image sensor (e.g., a complementary metal-oxide-semiconductor (CMOS) sensor or a charge-coupled device (CCD)). The video may include a plurality of image frames that are sequentially obtained by photographing an object through the camera 110. The image processing module may encode a still image consisting of a single image frame or video data consisting of a plurality of image frames obtained through the image sensor, and deliver a result of the encoding to the processor 130.

In an embodiment of the present disclosure, the camera 110 may be implemented in a small form factor to be mounted on the AR device 100, and may be implemented as a lightweight RGB camera with a low power consumption.

The camera 110 may include one camera or a plurality of cameras. In an embodiment of the present disclosure, when the AR device 100 is implemented as AR glasses, the camera 110 may include two cameras respectively arranged on a left-eye lens and a right-eye lens of the AR device 100. In this case, the two cameras may be configured as stereo cameras.

However, embodiments of the present disclosure are not limited thereto, and, in an embodiment of the present disclosure, the AR device 100 may include a plurality of cameras configured to photograph an object in the real world located in front of the user and a plurality of cameras having downwards-arranged lenses and configured to photograph the hands of the user. For example, the camera 110 may include two cameras for front photography and two cameras disposed downward to photograph the user's hands. In this case, the two cameras for front photography may be respectively disposed at the top of a frame surrounding the left and right lenses of the AR device 100, and the two cameras disposed facing downward to photograph the user's hands may be disposed at the bottom of the frame of the left and right lenses.

The sensor 120 is configured to obtain the 3D data about the real world around the user. According to an embodiment of the present disclosure, the sensor 120 may include at least one from among an infrared sensor 122, a depth camera 124, and a LIDAR sensor 126.

The infrared sensor 122 is configured to transmit infrared rays to an object in the real world and detect an infrared signal reflected by the object. The infrared sensor 122 may detect the intensity, transmission angle, and transmission location of the infrared signal. The infrared sensor 122 may provide information about the intensity, transmission angle, and transmission location of the infrared signal to the processor 130. The processor 130 may obtain a depth value for the object in the real world, based on sensing information obtained by the infrared sensor 122, and may obtain 3D data such as a depth map of the real world.

The depth camera 124 is configured to obtain depth information about the object in the real world. The “depth information” refers to information about a distance from the depth camera 124 (e.g., a depth sensor) to a specific object. In an embodiment of the present disclosure, the depth camera 124 may include a plurality of cameras, and may be configured as a stereo camera that obtains depth information of an object based on disparity and a relative position relationship between the cameras. However, embodiments of the present disclosure are not limited thereto, and the depth camera 124 (e.g., the depth sensor) may include a time of flight (TOF) sensor that radiates pattern light to the object by using a light source and obtains depth information based on a time it takes for the radiated pattern light to be reflected by the object and detected again, that is, a flight time.

The LiDAR sensor 126 is configured to detect at least one from among a distance, a direction, a speed, a temperature, a material distribution, or concentration characteristics by emitting a pulse laser to an object and measuring the time and intensity used by the pulse laser to return by being reflected by the object. The processor 130 may obtain 3D data, such as a depth map, of spatial structures, such as walls and objects in the real world, by using sensing information obtained through the LiDAR sensor 126.

The processor 130 may execute one or more instructions of a program stored in the memory 140. The processor 130 may include hardware elements that perform arithmetic, logic, input/output operations, and image processing. The processor 130 is illustrated as a single element in FIG. 3, but embodiments of the present disclosure are not limited thereto. According to an embodiment of the present disclosure, the processor 130 may be configured with a plurality of elements. The processor 130 may be a general-purpose processor (e.g., a central processing unit (CPU), an application processor (AP), or a digital signal processor (DSP)), a graphics-only processor (e.g., a graphics processing unit (GPU) or a vision processing unit (VPU)), or an artificial intelligence (AI)-only processor (e.g., a neural processing unit (NPU)). The processor 130 may control input data to be processed according to a predefined operation rule or artificial intelligence (AI) model. Alternatively, when the processor 130 is a dedicated AI processor, the dedicated AI processor may be designed in a hardware structure specialized for processing a specific AI model.

The processor 130 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing a variety of the recited/disclosed functions, e.g., in a distributed manner. At least one processor may execute program instructions to achieve or perform various functions.

The memory 140 may include at least one type of storage medium from among, for example, a flash memory type storage medium, a hard disk type storage medium, a multimedia card micro type storage medium, a card type memory (for example, SD or XD memory), a random access memory (RAM), a static RAM (SRAM), a read-only memory (ROM), an electrically erasable programmable ROM (EEPROM), a programmable ROM (PROM), and an optical disk.

The memory 140 may store instructions related to functions and/or operations, performed by the AR device 100, of determining an area optimal for overlaying a virtual keyboard among areas detected from the surrounding real world and adaptively displaying the virtual keyboard on the determined area. According to an embodiment of the present disclosure, at least one from among instructions (e.g., program code including, for example, an application program), an algorithm, and a data structure readable by the processor 130 may be stored in the memory 140. The instructions (e.g., the program code), algorithm, and data structure stored in the memory 140 may be implemented in, for example, programming or scripting languages such as C, C++, Java, assembler, and the like.

The memory 140 may store instructions (e.g., program code), algorithms, or data structures related to an area detection module 142, a virtual keyboard determination module 144, and a rendering module 146. A “module” included in the memory 140 refers to a unit processing a function or operation performed by the processor 130, and may be implemented as software, such as instructions (e.g., program code), algorithms, or data structures. According to an embodiment of the present disclosure, the memory 140 may include a virtual keyboard data storage 148.

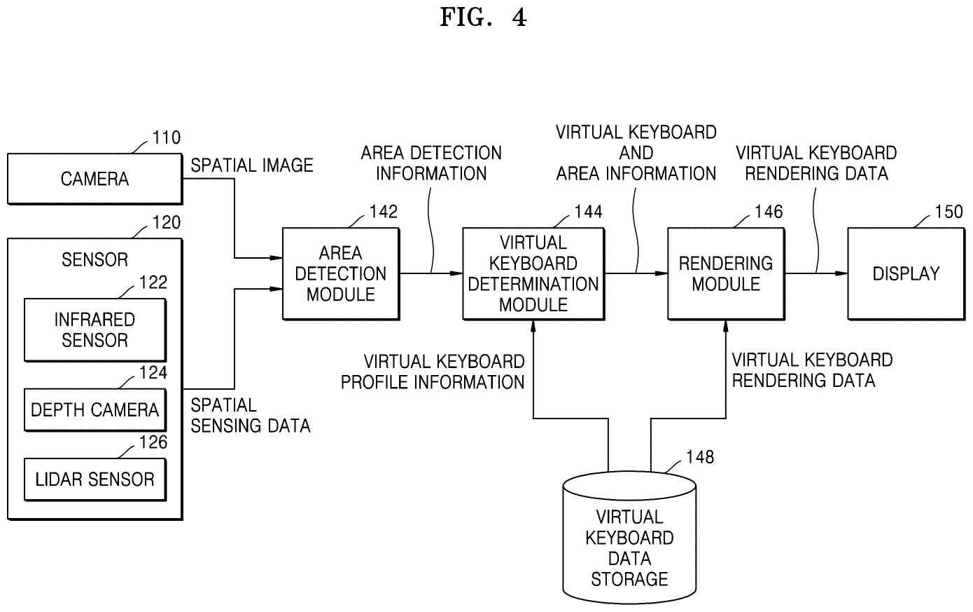

The processor 130 may perform its functions (e.g., implement the area detection module 142, the virtual keyboard determination module 144, and/or the rendering module 146) by executing the instructions (e.g., program code) stored in the memory 140. Hereinafter, functions and/or operations performed by the processor 130 by executing instructions (e.g., program code) of each of the plurality of modules stored in the memory 140, and data input and output between the plurality of modules and elements (e.g., the camera 110, the sensor 120, and the display 150) will be described in detail with reference to FIGS. 3 and 4.

FIG. 4 is a block diagram illustrating data input and output between the software modules stored in the memory 140 and the camera 110, the sensor 120, and the display 150 of the AR device 100 according to an embodiment of the present disclosure. According to embodiments of the present disclosure, the processor 130 (see FIG. 3) may perform a related function and/or operation by executing instructions (e.g., program code) of the area detection module 142, the virtual keyboard determination module 144, and the rendering module 146.

Referring to FIGS. 3 and 4, the area detection module 142 may include (or be configured by) instructions (e.g., program code) for executing a function and/or operation of detecting at least one area on which a virtual keyboard may be overlaid from the 3D data of the real world obtained through at least one from among the camera 110 and the sensor 120. The processor 130 may obtain a spatial image for the real world around the location of the AR device 100 from the camera 110 and obtain sensing data for the real world from the sensor 120. The processor 130 may obtain the 3D data about the real world, based on the spatial image and the sensing data. According to an embodiment of the present disclosure, the 3D data may include data that explicitly expresses a 3D shape of the surrounding's real world such as, for example, a point cloud or mesh, or 3D data in an abstract form, such as a signed distance function. The processor 130 may detect at least one area on which the virtual keyboard can be displayed from the 3D data about the real world, by executing instructions (e.g., program code) of the area detection module 142.

According to an embodiment of the present disclosure, the processor 130 may detect, from the 3D data of the real world, at least one area including a plane on which the virtual keyboard capable of being overlaid by using a plane detection algorithm. The processor 130 may detect a horizontal plane and a vertical plane from the 3D data of the real world, recognize planes included in the walls and floor in the real world from the detected horizontal plane and the detected vertical plane, and detect areas on the recognized planes. However, embodiments of the present disclosure are not limited thereto, and the processor 130 may recognize a plane composed of a window or a door as well as a wall and a floor from the 3D data. For example, the processor 130 may recognize the horizontal surface, such as a wall, floor, or desk surface in an office, from the 3D data of the surrounding environment.

However, embodiments of the present disclosure are not limited thereto, and the processor 130 may detect a surface with a preset curvature from the 3D data of the surrounding environment. According to an embodiment of the present disclosure, the processor 130 may recognize a surface having a curvature similar to a cylinder. The processor 130 may recognize a curved surface of a part of the user's body, such as the palm, the back of the hand, or the thigh, as at least one area to overlay the virtual keyboard.

According to an embodiment of the present disclosure, when a distance between the detected area and the user exceeds a preset threshold, the processor 130 may determine that the detected area is an area on which overlay of the virtual keyboard is impossible.

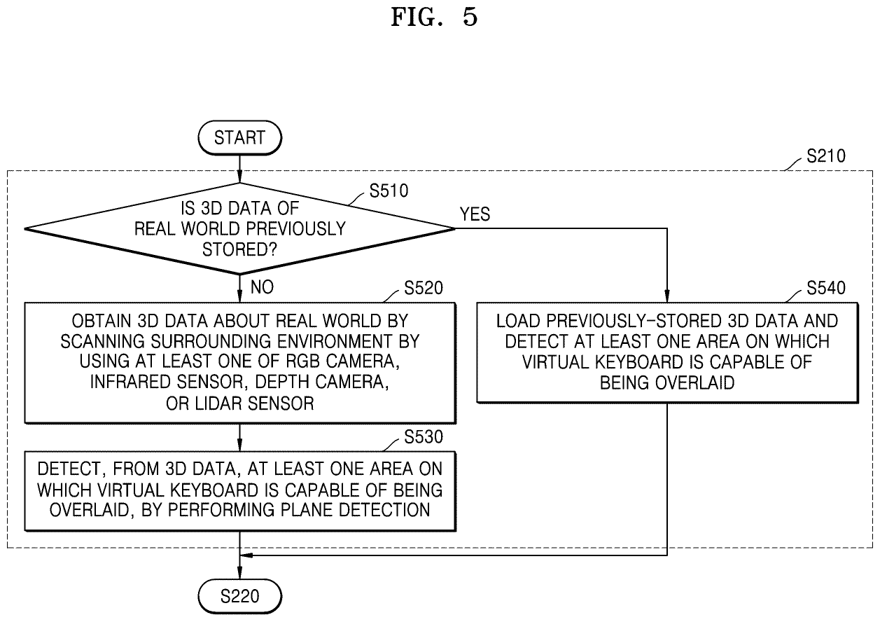

According to an embodiment of the present disclosure, the 3D data of the surrounding environment of the AR device 100 may be previously stored. In this case, the processor 130 may not obtain the 3D data of the surrounding real world based on the image or sensing data obtained through the camera 110 or the sensor 120, but may obtain the pre-stored 3D data by loading the same from the memory 140. An embodiment in which the 3D data about the real world around the AR device 100 is stored in advance will be described in detail with reference to FIG. 5.

The area detection module 142 may provide area detection information regarding the detected at least one area to the virtual keyboard determination module 144.

The virtual keyboard determination module 144 may include (or be configured by) instructions (e.g., program code) for executing a function and/or operation of determining a virtual keyboard that is capable of being overlaid on the at least one area, based on the profile information of the virtual keyboard. As used herein, the “profile information of the virtual keyboard” may include information about at least one from among the shape, size, and input language of the virtual keyboard. The “shape of the virtual keyboard” may include at least one from among, for example, a full-sized shape including all 106 keys, a split shape separable into multiple keyboard areas, a shape including only number keys, or a 12-key telephone keypad provided by a mobile device such as a cell phone. The size of the virtual keyboard may include information about a minimum displayable size and maximum displayable size at both of which the virtual keyboard is rendered. The input language of the virtual keyboard may include Korean, English, Chinese, Japanese, numbers, or special characters.

According to an embodiment of the present disclosure, the profile information of the virtual keyboard may be stored in the virtual keyboard data storage 148 in the memory 140, and the processor 130 may obtain (e.g., load) the profile information of the virtual keyboard from the virtual keyboard data storage 148. However, embodiments of the present disclosure are not limited thereto. According to an embodiment of the present disclosure, the AR device 100 may further include a communication interface configured to perform data communication with an external device or server, and the processor 130 may receive the profile information of the virtual keyboard from the server or external device through the communication interface.

The processor 130 may execute the instructions (e.g., program code) of the virtual keyboard determination module 144 to determine the type of virtual keyboard that is capable of being overlaid on the at least one area detected from the surrounding real world, based on the profile information of the virtual keyboard. As used herein, the “type of virtual keyboard” may include, for example, a QWERTY keyboard, a Cheonjiin keyboard, a numeric keyboard, or a 12-key English keyboard.

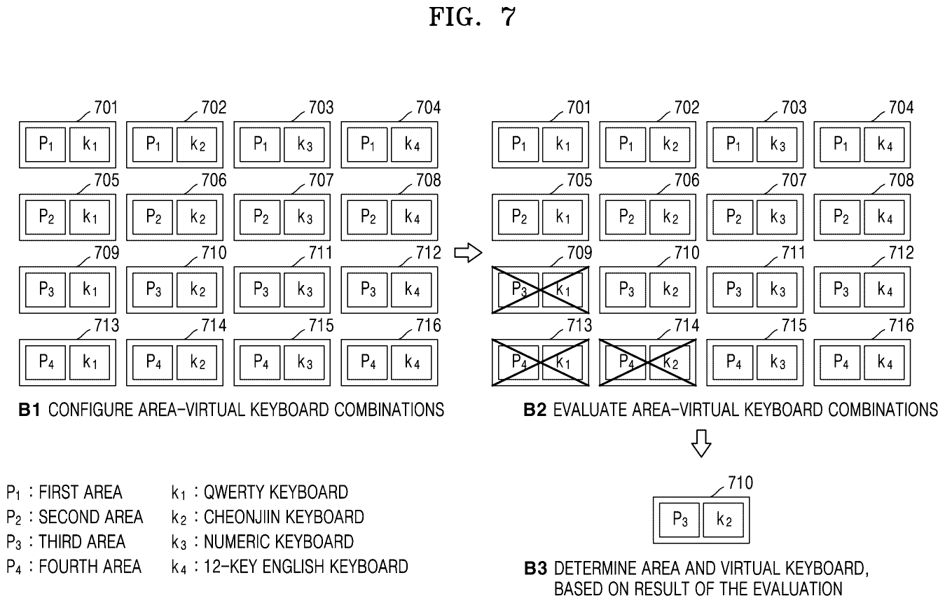

According to an embodiment of the present disclosure, the processor 130 may configure area-virtual keyboard combinations by matching the at least one area with all types of providable virtual keyboards. The processor 130 may match a plurality of types of virtual keyboards on one area. A specific embodiment in which the processor 130 configures the area-virtual keyboard combinations will be described in detail with reference to operation B1 of FIG. 7.

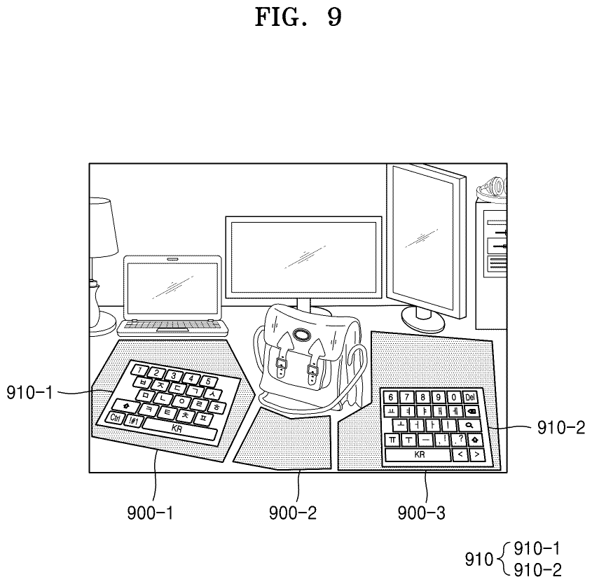

However, embodiments of the present disclosure are not limited thereto. According to an embodiment of the present disclosure, the processor 130 may separate a separable virtual keyboard into a plurality of keyboards and match the plurality of keyboards with a plurality of areas. An embodiment in which the processor 130 matches the spit type virtual keyboard with the plurality of areas will be described in detail with reference to FIG. 9.

The processor 130 may evaluate the area-virtual keyboard combinations, based on area's attribute information including the size and shape of the at least one area and at least one from among the shape, size, and input language of virtual keyboards, and calculate an evaluation score for the area-virtual keyboard combinations. For example, when the size of a first area among the at least one area is less than the minimum displayable size of a first virtual keyboard, the processor 130 may give a lower score than a reference score for a first combination consisting of the first area and the first virtual keyboard. According to an embodiment of the present disclosure, the processor 130 may calculate an evaluation score about the area-virtual keyboard combinations by considering the distance between the at least one area and the user together with the attribute information of the at least one area and the profile information including at least one from among the shape, size, and input language of virtual keyboards.

The processor 130 may determine the type of virtual keyboard that is capable of being overlaid on the at least one area, based on an evaluation result regarding the area-virtual keyboard combinations. According to an embodiment of the present disclosure, the processor 130 may determine that a virtual keyboard is capable of being overlaid on an area, only for area-virtual keyboard combinations of which calculated evaluation scores exceed a preset reference score. The processor 130 may determine that the virtual keyboard is incapable of being overlaid on an area constituting an area-virtual keyboard combination in which the calculated evaluation score is equal to or less than the reference score.

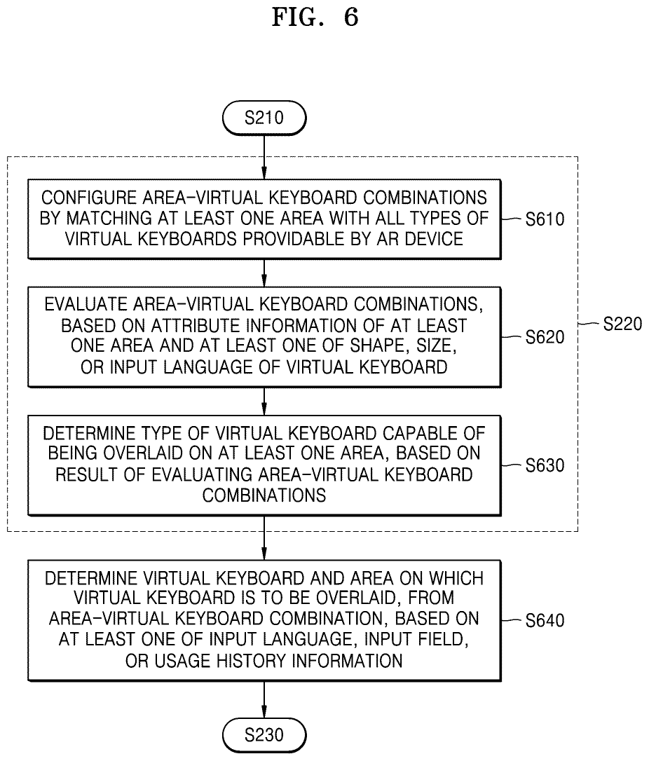

The processor 130 determines a virtual keyboard and an area on which the virtual keyboard is to be overlaid, from an area-virtual keyboard combination of at least one area and a type of virtual keyboard, based on at least one from among an input language, an input field, and usage history information. According to an embodiment of the present disclosure, the processor 130 may select an optimal area-virtual keyboard combination from among the area-virtual keyboard combinations, based on at least one from among the input language, the input field, and the usage history information. The processor 130 may determine a virtual keyboard included in the selected area-virtual keyboard combination, and may determine that the determined virtual keyboard is overlaid on the area included in the selected area-virtual keyboard combination. An embodiment in which the processor 130 configures area-virtual keyboard combinations by using the at least one area and the type of virtual keyboard and determines the virtual keyboard and the area on which the virtual keyboard is to be overlaid from the area-virtual keyboard combinations will be described in detail with reference to FIGS. 6 and 7.

The virtual keyboard determination module 144 may provide information about the determined virtual keyboard and the determined area to the rendering module 146.

The rendering module 146 may include (or be configured by) instructions (e.g., program code) for executing virtual keyboard rendering to display the virtual keyboard on the determined area. The processor 130 may perform rendering to display the virtual keyboard by overlaying the virtual keyboard on the determined area, by executing the instructions (e.g., program code) of the rendering module 146. The processor 130 may perform rendering to enlarge or reduce the size of the virtual keyboard by scaling the virtual keyboard so that the virtual keyboard is suitable for the size and shape of the determined area. According to an embodiment of the present disclosure, the processor 130 may load and obtain rendering data including image data, text data, or an applicable programming interface (API) related to the size, shape, and input language of the virtual keyboard from the virtual keyboard data storage 148, and may render the virtual keyboard by using the obtained rendering data.

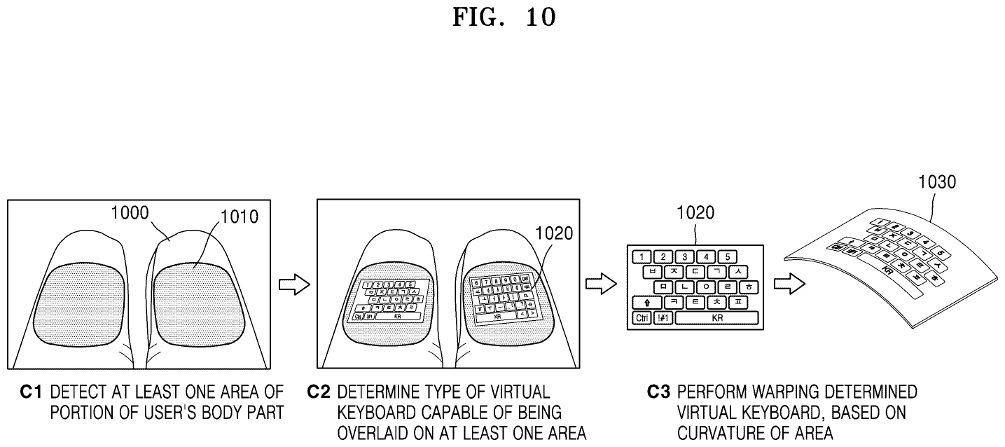

According to an embodiment of the present disclosure, when the determined area is a curved surface of a portion of the user's body part (e.g., the thigh), the processor 130 may perform rendering by warping the determined virtual keyboard, based on the curvature of the curved surface of the body part. An embodiment in which the processor 130 performs rendering by warping the virtual keyboard on a body part will be described in detail with reference to FIG. 10.

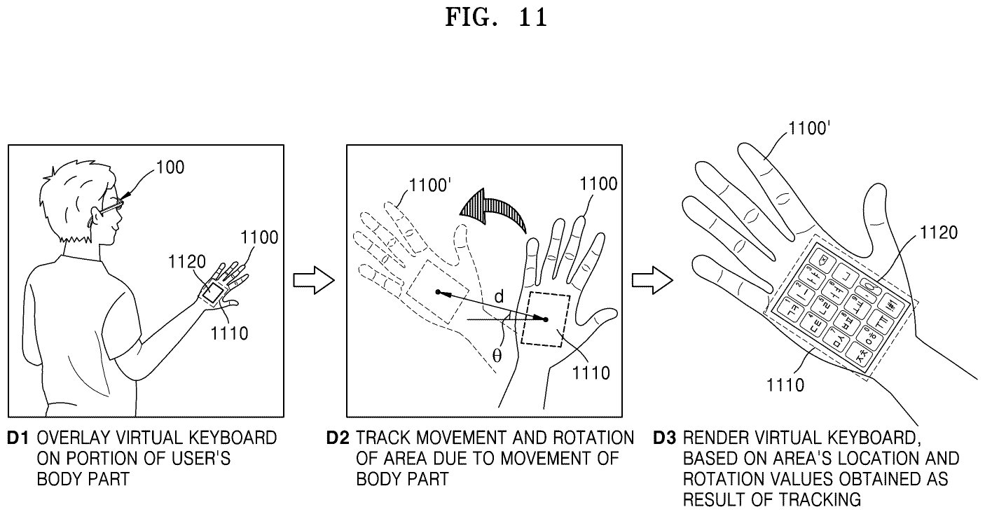

According to an embodiment of the present disclosure, when the virtual keyboard is rendered and overlaid on the surface of a portion of the user's body part and the surface moves due to the user's movement, the processor 130 may track the movement and rotation of the surface by photographing the body part through the camera 110, and may render the virtual keyboard, based on a moved location and rotation value of the surface obtained as a result of the tracking. An embodiment in which the processor 130 renders the virtual keyboard when the user moves his or her body will be described in detail with reference to FIG. 11.

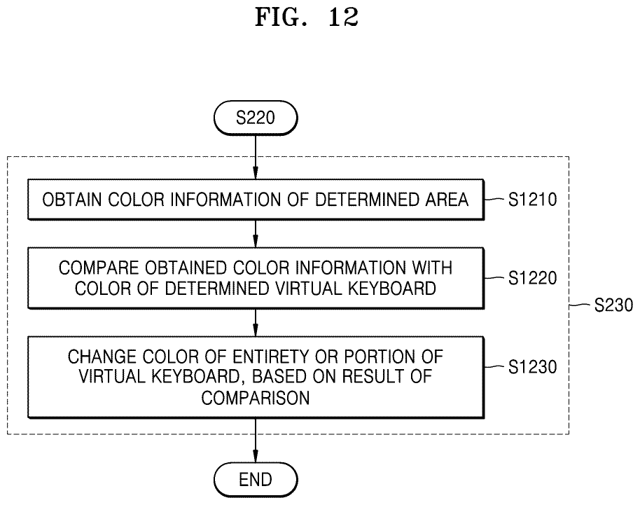

According to an embodiment of the present disclosure, the processor 130 may change the color of the entirety or a portion of the virtual keyboard by obtaining color information of the determined area and comparing the obtained color information of the area with the color of the virtual keyboard. An embodiment in which the processor 130 changes the color of the virtual keyboard to contrast with the color of the area in order to improve the visibility of the virtual keyboard will be described in detail later with reference to FIG. 12.

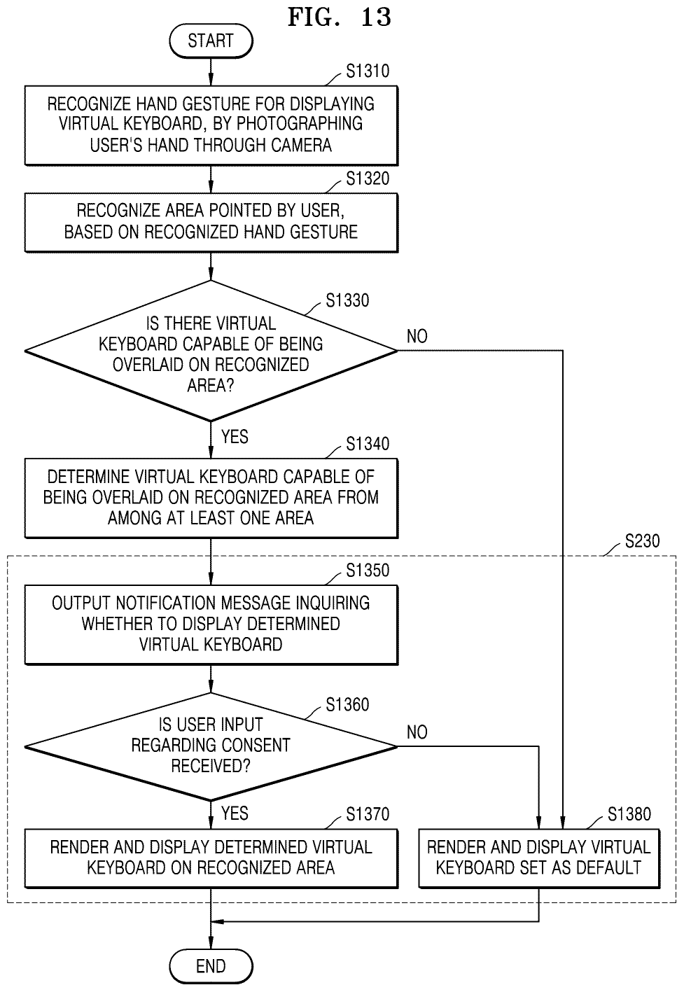

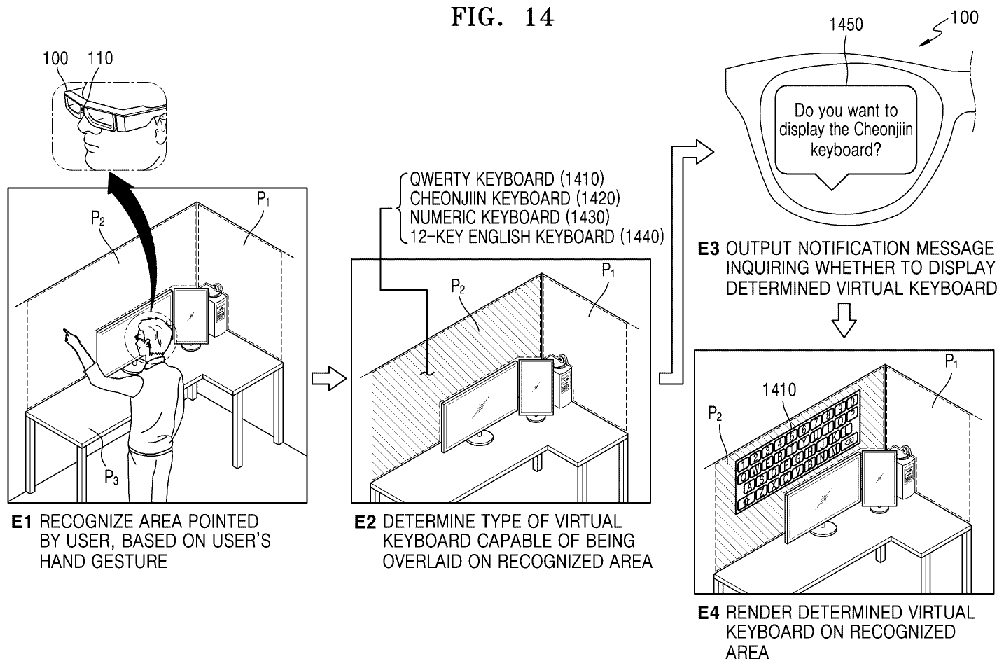

According to an embodiment of the present disclosure, the processor 130 may recognize the user's hand gesture from the image obtained through the camera 110, recognize an area pointed by the user based on the hand gesture, and render and display a virtual keyboard on the recognized area. An embodiment in which the processor 130 renders and displays the virtual keyboard on the recognized area, based on the user's hand gesture will be described in detail with reference to FIGS. 13 and 14.

The virtual keyboard data storage 148 is a data storage space that stores data related to virtual keyboards providable by the AR device 100. According to an embodiment of the present disclosure, the virtual keyboard data storage 148 may store profile information about at least one from among the shape, size, and input language of the virtual keyboard. However, embodiments of the present disclosure are not limited thereto, and the virtual keyboard data storage 148 may further include rendering data such as image data, text data, or API for rendering the virtual keyboard.

The virtual keyboard data storage 148 may be a non-volatile memory. The non-volatile memory refers to a storage medium that may store and maintain information even when power is not supplied and may use the stored information again when power is supplied. The non-volatile memory may include, for example, at least one of a flash memory, a hard disk, a solid state drive (SSD), a multimedia card micro type, and a card type memory (e.g., SD or XD memory), a ROM, a magnetic memory, a magnetic disk, or an optical disk.

FIG. 3 illustrates that the virtual keyboard data storage 148 is included in the memory 140, but embodiments of the present disclosure are not limited thereto. According to an embodiment of the present disclosure, the virtual keyboard data storage 148 may be configured as a database separate from the memory 140. For example, the virtual keyboard data storage 148 is accessible through a network, and may be configured as a web storage or cloud server that performs a storage function. In this case, the AR device 100 may communicate with a web storage or cloud server through a communication interface, and perform data transmission and reception to access the virtual keyboard data storage 148, thereby storing data related to the virtual keyboard.

The display 150 is configured to overlay and display the virtual keyboard on the determined area under a control by the processor 130. When the AR device 100 is implemented as AR glasses, the display 150 may be configured as a lens optical system, and may include a waveguide and an optical engine. The optical engine may include a projector configured to generate light of a virtual object configured as a virtual image and project the light to the waveguide. The optical engine may include, for example, an image panel, an illumination optical system, and a projection optical system. According to an embodiment of the present disclosure, the optical engine may be placed in the frame or temples of the AR glasses. According to an embodiment of the present disclosure, the optical engine may overlay and display the virtual keyboard on the area by generating light of a graphic object rendered as letters, numbers, special symbols, virtual images, or a combination thereof constituting the virtual keyboard and projecting the light onto the waveguide, under a control by the processor 130.

However, embodiments of the present disclosure are not limited thereto, and the display 150 may include at least one from among, for example, a liquid crystal display (LCD), a thin film transistor-liquid crystal display (TFT-LCD), an organic light-emitting diode (OLED), a flexible display, a three-dimensional (3D) display, and an electrophoretic display.

FIG. 5 is a flowchart of a method, performed by the AR device 100, of detecting at least one area by scanning a surrounding's real world, according to an embodiment of the present disclosure.

Operations S510 through S540 of FIG. 5 are detailed operations of operation S210 of FIG. 2. After any one of operations S530 and S540 shown in FIG. 5 is performed, operation S220 of FIG. 2 may be performed.

In operation S510, the AR device 100 determines whether 3D data of the real world is previously stored. According to an embodiment of the present disclosure, the 3D data regarding the surrounding's real world such as, for example, a real world including walls, floor, a desk, etc., in an office, may be pre-stored in the memory 140 (see FIG. 3). As used herein, the 3D data may include data that explicitly expresses a 3D shape of the surrounding's real world such as, for example, a point cloud or mesh, or 3D data in an abstract form, such as a signed distance function. The AR device 100 may scan the memory 140 to check whether the 3D data of the real world is stored in the memory 140.

According to an embodiment of the present disclosure, 3D data of a portion of the real world may be stored in the memory 140 of the AR device 100. For example, 3D data about an area of a half of a desk within an office may be stored in the memory 140. When all of the 3D data about the real world is not stored, the AR device 100 may determine that the 3D data is not stored in the memory 140.

According to an embodiment of the present disclosure, the AR device 100 may include a communication interface, and may receive the 3D data about the real world from an external server or external device. In this case, the AR device 100 may determine whether the received 3D data includes the 3D data about the surrounding's real world.

When the 3D data about the real world is not previously stored, the AR device 100 may obtain the 3D data about the real world by scanning the surrounding environment by using at least one from among an RGB camera, an infrared sensor, a depth camera, and a LIDAR sensor, in operation S520. According to an embodiment of the present disclosure, the AR device 100 may obtain at least one image frame by photographing the surrounding's real world through an RGB camera. According to an embodiment of the present disclosure, the AR device 100 may obtain sensing data about the real world through the infrared sensor, the depth camera, or the LiDAR sensor. Because the infrared sensor, the depth camera, and the LiDAR sensor are the same as the infrared sensor 122, the depth camera 124, and the LiDAR sensor 126 described above with reference to FIG. 3, overlapping descriptions thereof may be omitted. The AR device 100 may obtain the 3D data about the real world, based on at least one image frame obtained through the RGB camera and the sensing data obtained through the infrared sensor, the depth camera, or the LiDAR sensor.

In operation S530, the AR device 100 performs plane detection to detect, from the 3D data, at least one area on which the virtual keyboard is capable of being overlaid. The AR device 100 may detect, from the 3D data of the real world, at least one area including a plane or curved surface on which no objects are detected, by using a plane detection algorithm. According to an embodiment of the present disclosure, the AR device 100 may detect a horizontal plane and a vertical plane from the 3D data of the real world, recognize planes included in the walls and floor in the real world from the detected horizontal plane and the detected vertical plane, and detect an area in which no objects are arranged on the recognized plane. However, embodiments of the present disclosure are not limited thereto, and the AR device 100 may recognize a plane composed of a window or a door as well as a wall and a floor from the 3D data. For example, the AR device 100 may recognize the horizontal surface, such as a wall, floor, or desk surface in an office, from the 3D data of the surrounding environment. However, embodiments of the present disclosure are not limited thereto, and the AR device 100 may detect a surface with a preset curvature from the 3D data of the surrounding environment. According to an embodiment of the present disclosure, the AR device 100 may recognize a surface having a curvature similar to a cylinder. The processor 130 may recognize a curved surface of a part of the user's body, such as the palm, the back of the hand, or the thigh.

The AR device 100 may determine an area in which the virtual keyboard is not capable of being overlaid from the detected plane or curved surface. According to an embodiment of the present disclosure, when a distance between an area from among the areas of the detected plane or curved and the user exceeds a preset threshold, the AR device 100 may determine that the area is an area in which overlay of the virtual keyboard is impossible. The “overlay impossible area” may include, for example, an area outside the range of approximately 60 to 80 centimeters, which is the arm length of a typical person.

When the 3D data about the real world is previously stored, the AR device 100 loads the previously-stored 3D data and detects at least one area on which the virtual keyboard is capable of being overlaid, in operation S540. The AR device 100 may scan the memory 140 to load the pre-stored 3D data of the real world from the memory 140. The AR device 100 may detect the at least one area on which the virtual keyboard is capable of being overlaid, based on the loaded 3D data.

However, embodiments of the present disclosure are not limited thereto. According to an embodiment of the present disclosure, the AR device 100 may receive the 3D data about the real world from the external server or external device, and may detect the at least one area on which the virtual keyboard is capable of being overlaid from the received 3D data.

FIG. 6 is a flowchart of a method, performed by the AR device 100 according to an embodiment of the present disclosure, of determining the types of virtual keyboards capable of being overlaid on the at least one area, and determining a virtual keyboard of one of the determined types and an area where the virtual keyboard is to be overlaid.

Operations S610 through S630 of FIG. 6 are detailed operations of operation S220 of FIG. 2. After operation S640 shown in FIG. 6 is performed, operation S230 of FIG. 2 may be performed.

FIG. 7 is a flowchart of a method, performed by the AR device 100 according to an embodiment of the present disclosure, of determining the types of virtual keyboards (e.g., the first keyboard k₁, the second keyboard k₂, the third keyboard k₃, and the fourth keyboard k₄) that are capable of being overlaid on at least one area (e.g., first, second, third, and fourth areas P₁, P₂, P₃, and P₄), and determining a virtual keyboard of one of the determined types and an area where the virtual keyboard is to be overlaid. The shapes of the first, second, third, and fourth areas P₁, P₂, P₃, and P₄ shown in FIG. 7, the sizes thereof, and the number (e.g., “four”) thereof are examples for convenience of explanation, and at least one area and a virtual keyboard according to embodiments of the present disclosure are not limited to those shown in FIG. 7.

Hereinafter, a function and/or operation of the AR device 100 will be described in detail with reference to FIGS. 6 and 7.

Referring to FIG. 6, in operation S610, the AR device 100 configures area-virtual keyboard combinations by matching at least one area with all types of virtual keyboards providable by the AR device 100. Referring to operation B1 of FIG. 7, the processor 130 (see FIG. 3) of the AR device 100 may generate a total of 16 area-virtual keyboard combinations, namely, first, second, third, fourth, fifth, sixth, seventh, eighth, ninth, tenth, eleventh, twelfth, thirteenth, fourteenth, fifteenth, and sixteenth area-virtual keyboard combinations 701, 702, 703, 704, 705, 706, 707, 708, 709, 710, 711, 712, 713, 714, 715, and 716 by combining the first through fourth areas P₁ through P₄ with the first through fourth keyboards k₁ through k₄. For example, the processor 130 may configure the first area-virtual keyboard combination 701 by matching the first area P₁ with the first keyboard k₁, which is a QWERTY-type virtual keyboard. Likewise, the processor 130 may configure the second area-virtual keyboard combination 702 by matching the first area P₁ with the second keyboard k₂, which is a virtual keyboard of a Cheonjiin input method, configure the third area-virtual keyboard combination 703 by matching the first area P₁ with the third keyboard k₃, which is a virtual keyboard of a 12-key English keypad input method, and configure the fourth area-virtual keyboard combination 704 by matching the first area P₁ with the fourth keyboard k₄, which is a virtual keyboard of a numeric input method. Through the above-described method, the AR device 100 may obtain area-virtual keyboard combinations including the first through sixteenth area-virtual keyboard combinations 701 through 716. The configurations and number (e.g., 16) of area-virtual keyboard combinations shown in FIG. 7 are merely examples for convenience of explanation, and area-virtual keyboard combinations of embodiments of the present disclosure are limited to those shown in FIG. 7.

Referring back to FIG. 6, in operation S620, the AR device 100 evaluates the area-virtual keyboard combinations based on attribute information of the at least one area and at least one from among a shape, size, and input language of a virtual keyboard. According to an embodiment of the present disclosure, “attribute information of an area” may include information about the size and shape of the area. The AR device 100 may obtain profile information of all types of providable virtual keyboards. According to an embodiment of the present disclosure, “profile information” may include information about at least one from among the shape, size, and input language of a virtual keyboard. Because the profile information of the virtual keyboard and a specific method, performed by the AR device 100, of obtaining the profile information of the virtual keyboard are the same as those described above with reference to FIGS. 1 through 4, redundant descriptions thereof may be omitted.

The processor 130 of the AR device 100 may evaluate the area-virtual keyboard combinations, based on area's attribute information including the size and shape of the at least one area and the profile information including information about at least one from among the shapes, sizes, and input languages of virtual keyboards. According to an embodiment of the present disclosure, the AR device 100 may calculate evaluation scores about each of the area-virtual keyboard combinations by considering a distance between the at least one area and the user together with the attribute information of the at least one area and the profile information of the virtual keyboards. Referring to the embodiment shown in FIG. 7, the AR device 100 may evaluate the 16 area-virtual keyboard combinations, based on attribute information of the area included in each of the 16 area-virtual keyboard combinations and profile information of the virtual keyboard included in each of the 16 area-virtual keyboard combinations. For example, the processor 130 may perform evaluation on each of the first through sixteenth area-virtual keyboard combinations 701 through 716 and calculate an evaluation score for each of the first through sixteenth area-virtual keyboard combinations 701 through 716.

In operation S630 of FIG. 6, the AR device 100 determines the type of virtual keyboard capable of being overlaid on the at least one area, based on a result of evaluating the area-virtual keyboard combinations. According to an embodiment of the present disclosure, the AR device 100 may determine that a virtual keyboard capable of being overlaid on an area only for area-virtual keyboard combinations of which calculated evaluation scores exceed a preset reference score. Referring to operation B2 of FIG. 7, for example, the processor 130 of the AR device 100 may determine that the first keyboard k₁, the second keyboard k₂, the third keyboard k₃, and the fourth keyboard k₄ are all capable of being overlaid on the first area P₁, based on the evaluation scores calculated for the first through fourth area-virtual keyboard combinations 701 through 704. Likewise, the processor 130 of the AR device 100 may determine that the first keyboard k₁, the second keyboard k₂, the third keyboard k₃, and the fourth keyboard k₄ are all capable of being overlaid on the second area P₂, based on the evaluation scores calculated for the fifth through eighth area-virtual keyboard combinations 705 through 708. The processor 130 may determine that it is impossible to overlay the first keyboard k₁, which is a QWERTY-type virtual keyboard, on the third area P₃ constituting the ninth area-virtual keyboard combination 709 having an evaluation score lower than a preset threshold from among the evaluation scores calculated for the ninth through twelfth area-virtual keyboard combinations 709 through 712. The processor 130 may determine that the first keyboard k₁, the second keyboard k₂, the third keyboard k₃, and the fourth keyboard k₄ are all capable of being overlaid on the third area P₃. The processor 130 may determine that it is impossible to overlay a virtual keyboard on an area for the thirteenth and fourteenth area-virtual keyboard combinations 713 and 714 having lower evaluation scores than the preset threshold from among the evaluation scores calculated for the thirteenth through sixteenth area-virtual keyboard combinations 713 through 716. For example, the processor 130 may determine that only the third keyboard k₃ and the fourth keyboard k₄ are capable of being overlaid on the fourth area P₄.

Referring to operation S640 of FIG. 6, the AR device 100 may select an optimal area-virtual keyboard combination from among the area-virtual keyboard combinations, based on at least one from among the input language, the input field, and the usage history information. The “input field” may include, for example, a login field, a field for inputting English or Korean alphabet Hangul (such as, a text input field), and a field for inputting numbers (such as, a password input field). The “usage history information” may include, for example, history information about the frequency of use of a specific type of keyboard (e.g., a QWERTY keyboard or a Cheonjiin keyboard) by a user and the keyboard type, size, etc., most recently used by the user.

The AR device 100 may determine that a virtual keyboard included in a selected area-virtual keyboard combination is overlaid on a selected area. Referring to operation B3 of FIG. 7, the processor 130 of the AR device 100 may determine the tenth area-virtual keyboard combination 710 as an optimal area-virtual keyboard combination from among the first through sixteenth area-virtual keyboard combinations 701 through 716, based on at least one from among the input language, the input field, and the usage history information. For example, when the language the user wants to input is Hangul (Korean alphabet), the input field is a text input field, and the type of keyboard frequently used by the user is the Cheonjiin keyboard, the processor 130 may determine the third area P₃ and the second keyboard k₂ as a virtual keyboard to be overlaid on the third area P₃ by comprehensively considering the input language, the input field, and the usage history information.

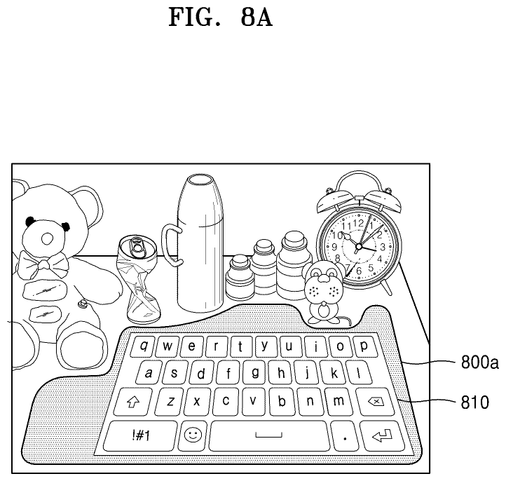

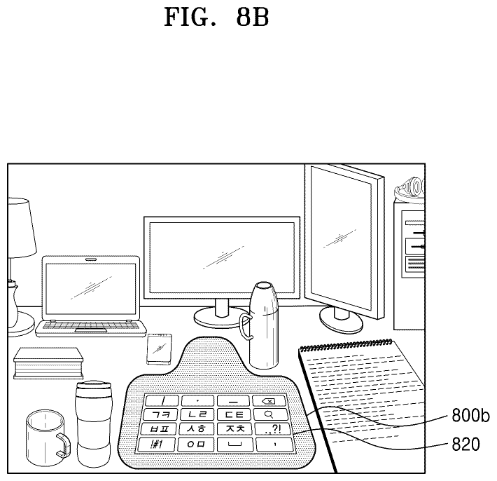

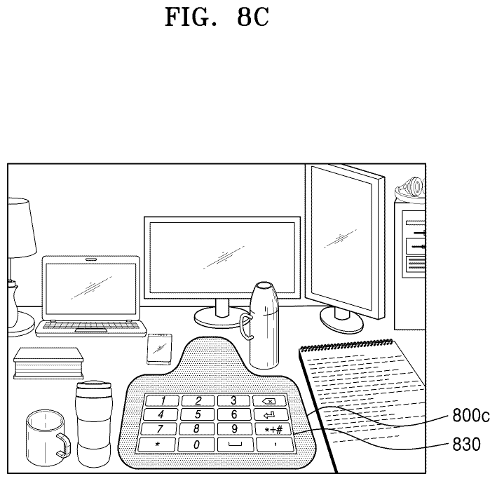

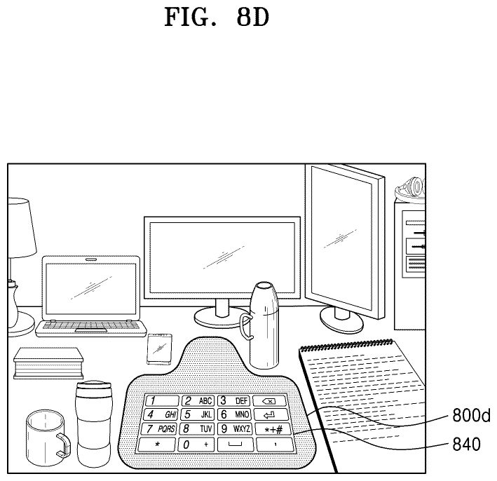

FIG. 8A is a diagram illustrating an embodiment of the present disclosure in which the AR device 100 overlays and displays a first virtual keyboard 810 of a QWERTY type on a first area 800a.

Referring to FIG. 8A, the processor 130 (see FIG. 3) of the AR device 100 may determine the first area 800a as an area to overlay a virtual keyboard thereon, and may determine the type of virtual keyboard capable of being overlaid on the first area 800a based on attribute information including the size and shape of the first area 800a and profile information of the virtual keyboard. In the embodiment shown in FIG. 8A, the first area 800a may be a surface of a desk on which real-world objects, such as dolls, water bottles, cans, and clocks, are arranged. The processor 130 may obtain attribute information about the size and shape of the first area 800a on the desk from the image obtained through the camera 110 (see FIG. 3) or the sensing data obtained through the sensor 120. The processor 130 may determine the first virtual keyboard 810 of a QWERTY type as a virtual keyboard to be overlaid on the first area 800a, based on the attribute information of the first area 800a and profile information including at least one from among the shape, size, and input language of a QWERTY-type virtual keyboard.

FIG. 8B is a diagram illustrating an embodiment of the present disclosure in which the AR device 100 overlays and displays a second virtual keyboard 820 of a Cheonjiin input method on a second area 800b.

Referring to FIG. 8B, the processor 130 (see FIG. 3) of the AR device 100 may determine the second area 800b as an area to overlay a virtual keyboard thereon, and may determine the type of virtual keyboard capable of being overlaid on the second area 800b, based on attribute information including the size and shape of the second area 800b and profile information of the virtual keyboard. In the embodiment shown in FIG. 8B, the second area 800b may be the surface of a desk on which real-world objects, such as a monitor, a water bottle, and a notebook, are placed, and the size of the second area 800b may be less than the size of the first area 800a (see FIG. 8A). The processor 130 may obtain attribute information about the size and shape of the second area 800b on the desk from the image obtained through the camera 110 (see FIG. 3) or the sensing data obtained through the sensor 120. The processor 130 may determine the second virtual keyboard 820 of a Cheonjiin input method as a virtual keyboard to be overlaid on the second area 800b, based on the attribute information of the second area 800b and profile information including at least one from among the shape, size, and input language of a Cheonjiin-type virtual keyboard.

FIG. 8C is a diagram illustrating an embodiment of the present disclosure in which the AR device 100 overlays and displays a third virtual keyboard 830 of a numeric key type on a third area 800c. Because the size and shape of the third area 800c in the embodiment shown in FIG. 8C are substantially the same as the size and shape of the second area 800b shown in FIG. 8B, redundant descriptions thereof may be omitted.

Referring to FIG. 8C, the processor 130 (see FIG. 3) of the AR device 100 may determine the third area 800c as an area to overlay a virtual keyboard thereon, and may determine the third virtual keyboard 830, which is a virtual keyboard of a numeric key input method, as a virtual keyboard capable of being overlaid on the third area 800c, based on attribute information including the size and shape of the third area 800c and profile information of the virtual keyboard. The embodiment shown in FIG. 8C is the same as the embodiment shown in FIG. 8B except that the virtual keyboard to be overlaid on the third area 800c is the third virtual keyboard 830, so redundant descriptions thereof may be omitted.

FIG. 8D is a diagram illustrating an embodiment of the present disclosure in which the AR device 100 overlays and displays a fourth virtual keyboard 840 of a 12-key English keypad input method on a fourth area 800d. Because the size and shape of the fourth area 800d in the embodiment shown in FIG. 8D are substantially the same as the size and shape of the second area 800b shown in FIG. 8B, redundant descriptions thereof may be omitted.

Referring to FIG. 8D, the processor 130 (see FIG. 3) of the AR device 100 may determine the fourth area 800d as an area to overlay a virtual keyboard thereon, and may determine the fourth virtual keyboard 840, which is a virtual keyboard of a 12-key English keypad input method, as a virtual keyboard capable of being overlaid on the fourth area 800d, based on attribute information including the size and shape of the fourth area 800d and profile information of the virtual keyboard. The embodiment shown in FIG. 8D is the same as the embodiment shown in FIG. 8B except that the virtual keyboard to be overlaid on the fourth area 800d is the fourth virtual keyboard 840, so redundant descriptions thereof may be omitted.

According to an embodiment of the present disclosure, the processor 130 (see FIG. 3) of the AR device 100 may determine a virtual keyboard that is to be overlaid on an area from among types of virtual keyboards, based on at least one from among the input language, the input field, and the usage history information. For example, when the input language is Hangul (Korean alphabet), the input field is a field for inputting text, and the history information is confirmed that the user frequently used the Cheonjiin keyboard, the processor 130 may determine the second virtual keyboard 820 of the Cheonjiin input method as a virtual keyboard that is to be overlaid on the second area 800b, as shown in FIG. 8B. For example, when the input language is numbers and the input field is a numeric input field for inputting bank account numbers or the amount of money in a bank application, the processor 130 may determine the third virtual keyboard 830, which is a virtual keyboard for inputting numbers, as a virtual keyboard that is to be overlaid on the third area 800c, as shown in FIG. 8C. For example, when the input language is English and numeric and the history information indicates that the user frequently used a 12-key input type keyboard, the processor 130 may determine the fourth virtual keyboard 840 of the 12-key English keypad input method as a virtual keyboard that is to be overlaid on the fourth area 800d, as shown in FIG. 8D.

FIG. 9 is a diagram for explaining an operation, performed by the AR device 100, of overlaying and displaying a split type keyboard 910 on a plurality of areas (e.g., first, second, and third areas 900-1, 9002, and 900-3), according to an embodiment of the present disclosure.

Referring to FIG. 9, the AR device 100 may match the split type keyboard 910 that may be split into multiple pieces overlaid and displayed on a plurality of areas (e.g., first, second, and third areas 900-1, 900-2, and 900-3). According to an embodiment of the present disclosure, the split type keyboard 910 may be split into a plurality of keyboards (e.g., a left keyboard 910-1 and a right keyboard 910-2). For example, the split type keyboard 910 is a virtual keyboard with a QWERTY keyboard input method, and may be split into two keyboards including the left keyboard 910-1 and the right keyboard 910-2. In the embodiment shown in FIG. 9, the processor 130 (see FIG. 3) of the AR device 100 may match the left keyboard 910-1 such that the left keyboard 910-1 is overlaid on the first area 900-1 among the plurality of areas (e.g., the first through third areas 900-1, 900-2, and 900-3), and may match the right keyboard 910-2 such that the right keyboard 910-2 is overlaid on the third area 900-3 among the plurality of areas (e.g., the first through third areas 900-1, 900-2, and 900-3).

Although the split type keyboard 910 shown in FIG. 9 is shown and described as being split into the two keyboards including the left keyboard 910-1 and the right keyboard 910-2, this is merely an example, and a split type keyboard of embodiments of the present disclosure are not limited to that shown in FIG. 9.

As in the embodiment shown in FIG. 9, many real-world objects (e.g., a monitor, a bag, and a stand light) are arranged on the flat surface of a desk, so, when the size of an area is less than that of a virtual keyboard of a QWERTY input method, the AR device 100 may split the split type keyboard 910 into the plurality of keyboards (e.g., the left keyboard 910-1 and the right keyboard 910-2) and overlay the plurality of keyboards (e.g., the left keyboard 910-1 and the right keyboard 910-2) on the plurality of areas (e.g., the first area 900-1 and the third area 900-3). The AR device 100 according to an embodiment of the present disclosure overlays the split type keyboard 910 even when real-world objects are placed on a plane and thus an area where a virtual keyboard is capable of being overlaid has a small size, thereby improving the utilization of the area.

FIG. 10 is a view illustrating an operation, performed by the AR device 100, of overlaying and displaying a virtual keyboard on a body part 1000 of a user, according to an embodiment of the present disclosure.

Referring to FIG. 10, the AR device 100 detects at least one area of a portion of the user's body part 1000 (operation C1). In an embodiment of the present disclosure, the AR device 100 may detect a flat or curved surface of the user's body part 1000, based on an image obtained by photographing the user's body through the camera 110 (see FIG. 3) or sensing data obtained through the sensor 120 (see FIG. 3). The AR device 100 may detect an area 1010 on which the virtual keyboard is capable of being overlaid from the detected flat or curved surface. In an embodiment of the present disclosure, the “area 1010 on which the virtual keyboard is capable of being overlaid” may include an area from which no object is detected on the flat or curved surface. The area 1010 on which the virtual keyboard is capable of being overlaid may be provided as one area or a plurality of areas.

In the embodiment shown in FIG. 10, the processor 130 may detect thighs among the body parts of the user as the area 1010 on which the virtual keyboard is capable of being overlaid. For example, the area 1010 on which the virtual keyboard is capable of being overlaid is partial areas of the user's left thigh and right thigh, and may be an area split into two areas. However, embodiments of the present disclosure are not limited to the embodiment of FIG. 10, and the processor 130 may detect areas of the user's other body parts (e.g., the palms, backs of the hands, wrists, or shoulders) as the area 1010 on which the virtual keyboard is capable of being overlaid.

The AR device 100 determines the type of virtual keyboard capable of being overlaid on the at least one area 1010 (operation C2). The processor 130 of the AR device 100 may determine the type of virtual keyboard capable of being overlaid on the at least one area 1010, based on area's attribute information including the size and shape of the at least one area 1010 and the profile information including information about at least one from among the shapes, sizes, and input languages of virtual keyboards. In an embodiment of the present disclosure, the processor 130 may configure area-virtual keyboard combinations by matching the at least one area 1010 with all types of providable virtual keyboards, performing an evaluation on the area-virtual keyboard combinations, based on area's attribute information and profile information of the virtual keyboards, and determining the type of virtual keyboard capable of being overlaid on the at least one area 1010, based on a result of the evaluation. In the embodiment shown in FIG. 10, the processor 130 may determine a virtual keyboard 1020 of a split type as a virtual keyboard capable of being overlaid on the area 1010 on the user's left and right thighs.

The AR device 100 performs warping the virtual keyboard 1020, that is determined, based on the curvature of the area (operation C3). According to an embodiment of the present disclosure, when the determined area is a curved surface of a portion of the user's body part (i.e., the thigh in the embodiment of FIG. 10), the processor 130 of the AR device 100 may perform rendering by warping the virtual keyboard 1020, that is determined, based on the curvature of the curved surface of the body part. The “warping” refers to an image processing technology of changing the positions of pixels that constitute an image. Image warping is a type of geometric transformation capable of changing the positions of pixels included in the original image. Image warping may be performed based on parameters including a transformation function for changing the positions of pixels.

In an embodiment of the present disclosure, the processor 130 may obtain depth value information of a body part, obtain a warping parameter, based on the obtained depth value information, and perform warping on the virtual keyboard 1020, based on the obtained warping parameter. However, embodiments of the present disclosure are not limited thereto. According to an embodiment of the present disclosure, the processor 130 may perform warping on the virtual keyboard 1020, based on a warping parameter value previously set for each body part. Referring to the embodiment of FIG. 10, the AR device 100 may obtain a warped virtual keyboard 1030, based on the curvature of the area 1010 on the thigh as warping is performed.

In a case that a non-flat curved surface of the user's body part 1000 (e.g., a thigh, a palm, a wrist, or the back of a hand) is determined as the area 1010 on which the virtual keyboard 1020 is to be overlaid, if the virtual keyboard 1020 is overlaid in the form of a flat surface, the virtual keyboard 1020 and the area 1010 configured with a curved surface do not completely match with each other and thus there is a gap therebetween. Thus, in the comparative embodiment, it is inconvenient for the user to manipulate the virtual keyboard 1020, and a recognition rate when entering keys may decrease. The AR device 100 according to the embodiment shown in FIG. 10 may provide a technical effect of improving manipulation convenience and a key input recognition rate by overlaying the warped virtual keyboard 1030 obtained by warping the virtual keyboard 1020, based on the curvature of the area 1010 (e.g., a partial area) of the user's body part 1000.

FIG. 11 is a view illustrating an operation, performed by the AR device 100, of tracking a movement of a body part 1100 of a user and displaying a virtual keyboard 1020, according to an embodiment of the present disclosure.

Referring to FIG. 11, the AR device 100 overlays a virtual keyboard on a portion of the user's body part 1100 (operation D1). The processor 130 (see FIG. 3) of the AR device 100 may detect a flat or curved surface from the user's body part 1100, based on an image obtained by photographing the user's body by using the camera 110 (see FIG. 3) or sensing data obtained through the sensor 120 (see FIG. 3), and may detect an area 1110 on which a virtual keyboard is capable of being overlaid among the detected flat or curved surface. The processor 130 may determine the type of virtual keyboard capable of being overlaid on the area 1110 that is detected, and overlay and display the virtual keyboard 1120, that is determined, on the area 1110 that is detected. A detailed method, performed by the processor 130, of detecting a partial area (e.g., the area 1110 that is detected) from the user's body part 1100 and determining the type of virtual keyboard 1120 capable of being overlaid on the area 1110, that is detected, is the same as that described above with reference to FIGS. 1 through 4 and FIG. 10, and so redundant descriptions may be omitted. In the embodiment shown in FIG. 11, the processor 130 may detect the area 1110 on the user's body part 1100 (e.g., a palm), and overlay and display the virtual keyboard 1120 of a Cheonjiin input method on the area 1110 that is detected.

The AR device 100 tracks movement and rotation of the area 1110 due to the movement of the body part 1100 (operation D2). In an embodiment of the present disclosure, when the area 1110 moves due to the user's movement while the virtual keyboard 1120 is being overlaid on the area 1110 of the user's body part 1100, the processor 130 may obtain a plurality of image frames by photographing the body part 1100 through the camera 110, recognize a moved area 1110′ from the obtained plurality of image frames, and track the location and rotation of the moved area 1110′. As a result of the tracking, the processor 130 may obtain location and rotation values of the moved area 1110′. In the embodiment shown in FIG. 11, the processor 130 may obtain information of a distance d and a rotation angle θ between the moved area 1110′ and the area 1110 not yet moved, as a result of the tracking.

The AR device 100 renders the virtual keyboard 1120, based on the area's location and rotation values obtained as a result of the tracking (operation D3). In the embodiment shown in FIG. 11, the processor 130 of the AR device 100 may render the virtual keyboard 1120, based on the distance d and the rotation angle θ between the moved area 1110′ and the area 1110 not yet moved. The processor 130 may overlay and display the virtual keyboard 1120, that is rendered, on the moved area 1110′.

The AR device 100 according to the embodiment shown in FIG. 11 renders and displays the virtual keyboard 1120 on the moved area 1110′ when the user's body part 1100 moves or a relative position movement and a rotation value change occur due to a head movement of the user while the virtual keyboard 1120 is being overlaid and displayed on the user's body part 1100. Thus, the user may be enabled to manipulate the virtual keyboard 1120 with continuity, resulting in an improvement in manipulation convenience.

FIG. 12 is a flowchart of a method, performed by the AR device 100, of changing the color of a virtual keyboard, based on color information of an area on which the virtual keyboard is overlaid, according to an embodiment of the present disclosure.

Operations S1210 through S1230 of FIG. 12 are detailed operations of operation S230 of FIG. 2. Operation S1210 of FIG. 12 may be performed after operation S220 of FIG. 2 is performed.

In operation S1210, the AR device 100 obtains color information of the determined area. In an embodiment of the present disclosure, the processor 130 (see FIG. 3) may control the camera 110 (see FIG. 3) of the AR device 100 to obtain an image by photographing an area, and may obtain color information of the area by analyzing the image obtained by the camera 110. For example, the processor 130 may obtain the color information of the area from the image by using well-known image processing technology. However, embodiments of the present disclosure are not limited thereto, and the processor 130 may also obtain the color information of the area by using an artificial intelligence model trained so that the color information is output when the image is input.

In operation S1220, the AR device 100 compares the obtained color information with the color of the determined virtual keyboard. According to an embodiment of the present disclosure, the processor 130 of the AR device 100 may obtain color information of the virtual keyboard from the profile information of the virtual keyboard. The processor 130 may compare obtain the color information of the area obtained in operation S1210 with the color of the virtual keyboard.

In operation S1230, the AR device 100 changes the color of the entirety or a portion of the virtual keyboard, based on a result of the comparison. For example, when the color of the area is black, the processor 130 of the AR device 100 may change the color of the virtual keyboard to a color with higher visibility than black, such as white, yellow, or gray. According to an embodiment of the present disclosure, the processor 130 may change the color of the virtual keyboard to a color having a complementary relationship with the color of the area. For example, when the color of the area is green, the processor 130 may change the color of the virtual keyboard to red, which is a complementary color to green. As another example, when the color of the area is yellow, the processor 130 may change the color of the virtual keyboard to purple, which is a complementary color to yellow.

The processor 130 may change the overall color of the virtual keyboard, but embodiments of the present disclosure are not limited thereto. According to an embodiment of the present disclosure, the processor 130 may change the color of a partial area of the virtual keyboard or each of the character keys of the virtual keyboard.

The AR device 100 according to the embodiment shown in FIG. 12 may improve the visibility of the virtual keyboard by obtaining the color information of the area and changing the color of the virtual keyboard to a color that may contrast with the color of the area.

FIG. 13 is a flowchart of a method, performed by the AR device 100, of displaying a virtual keyboard on a determined area, based on a hand gesture of a user, according to an embodiment of the present disclosure.

FIG. 14 is a view illustrating an operation, performed by the AR device 100, of displaying a virtual keyboard (e.g., a first keyboard 1410) on a determined area (e.g., a second area P₂,) based on a hand gesture of a user, according to an embodiment of the present disclosure.

Hereinafter, a function and/or operation of the AR device 100 will be described in detail with reference to FIGS. 13 and 14.

In operation S1310, the AR device 100 recognizes a hand gesture for displaying a virtual keyboard by photographing the user's hand through the camera 110 (see FIG. 14). Referring to the embodiment shown in FIG. 14, the AR device 100 may obtain an image by photographing the user's hand by using the camera 110, and the processor 130 (see FIG. 3) may recognize the user's hand from the obtained image and may recognize a hand gesture made by the recognized user's hand. Because hand gesture recognition technology is a well-known technology in the art, a detailed description thereof may be omitted.

In operation S1320, the AR device 100 recognizes an area pointed by the user, based on the recognized hand gesture. According to an embodiment of the present disclosure, the AR device 100 may recognize the area pointed by the user's hand from the image according to a result of the recognition of the hand gesture. Referring to the embodiment shown in FIG. 14, the first through third areas P₁ through P₃ are areas determined as areas on which a virtual keyboard is capable of being overlaid, and the first area P₁ and the second area P₂ may be wall surfaces, and the third area P₃ may be a flat surface on a desk. In operation E1 of FIG. 14, the processor 130 of the AR device 100 may recognize the user's hand gesture pointing to any one from among the first area P₁, the second area P₂, and the third area P₃ included in a surrounding's real world, and may recognize the second area P₂ pointed by the user according to a result of the recognition of the hand gesture.

In operation S1330, the AR device 100 determines whether there is a virtual keyboard capable of being overlaid on the recognized area. According to an embodiment of the present disclosure, the processor 130 of the AR device 100 may identify the type of virtual keyboard capable of being overlaid on the recognized area, based on attribute information including the size and shape of the recognized area and profile information about at least one from among the shapes, sizes, and input languages of virtual keyboards. The processor 130 may configure area-virtual keyboard combinations by matching the recognized area with all types of virtual keyboards providable by the AR device 100, perform an evaluation on the area-virtual keyboard combinations, based on attribute information of the recognized area and profile information of the virtual keyboards, and determine whether there is a virtual keyboard capable of being overlaid on the recognized area, based on a result of the evaluation. A detailed method, performed by the processor 130, of determining or identifying the type of virtual keyboard capable of being overlaid on an area is the same as that described above with reference to FIGS. 6 and 7, and thus redundant descriptions thereof may be omitted. Referring to FIG. 12 together with the embodiment shown in FIG. 14, the processor 130 may identify, as capable of being an overlaid virtual keyboard, a first keyboard 1410, which is a virtual keyboard of the QWERTY input method, a second keyboard 1420, which is a virtual keyboard of the Cheonjiin input method, a third keyboard 1430, which is a virtual keyboard for numeric input, and a fourth keyboard 1440, which is a 12-key English keypad.

When it is determined in operation S1330 that there is a virtual keyboard capable of being overlaid on the recognized area, the AR device 100 determines a virtual keyboard capable of being overlaid on the recognized area from among at least one area, in operation S1340. According to an embodiment of the present disclosure, the processor 130 of the AR device 100 may determine one type of virtual keyboard among the types of virtual keyboards capable of being overlaid on an area, based on at least one from among an input language, an input field, and usage history information. Referring to the example of operation E2 of FIG. 14, when the input language is Hangul or English, the input field is a text input field, and the keyboard most recently used by the user is a virtual keyboard of the QWERTY input method, the processor 130 may determine the first keyboard 1410, which is a QWERTY keyboard, as the virtual keyboard capable of being overlaid on the recognized area.

Operations S1350 through S1380 of FIG. 13 are detailed operations of operation S230 of FIG. 2. In operation S1350, the AR device 100 outputs a notification message 1450 (see FIG. 14) inquiring whether to display the determined virtual keyboard. Referring to operation E3 of FIG. 14 together, the AR device 100 may output the notification message 1450 inquiring “Do you want to display the Cheonjiin keyboard?”

In operation S1360, the AR device 100 determines whether a user input regarding consent is received.

However, embodiments of the present disclosure are not limited thereto. In an embodiment of the present disclosure, operations S1350 and S1360 and operation E3 of FIG. 14 are not performed and may be omitted.

When it is determined in operation S1360 that the user's consent input in response to the notification message is received, the AR device 100 renders and displays the determined virtual keyboard on the recognized area, in operation S1370. Referring to operation E4 of FIG. 14, the processor 130 of the AR device 100 may render the first keyboard 1410, which is the determined virtual keyboard, and controls the display 150 (see FIG. 3) to overlay the first keyboard 1410 on the second area P₂. According to an embodiment of the present disclosure, the processor 130 may control the optical engine of the display 150 to generate light of a graphic object composed of letters, numbers, special symbols, virtual images, or a combination thereof constituting the first keyboard 1410 that is rendered, and project the light onto the waveguide of the display 150, thereby overlaying and displaying the first keyboard 1410 on the second area P₂.

On the other hand, when it is determined in operation S1330 that there is no virtual keyboard capable of being overlaid on the recognized area, the AR device 100 renders and displays a virtual keyboard set as default, in operation S1380. The virtual keyboard set as default may be previously set by the user. However, embodiments of the present disclosure are not limited thereto, and the virtual keyboard set as default may be preset when the AR device 100 is shipped from the factory.

When it is determined in operation S1360 that no user's consent input is received, the AR device 100 renders and displays the virtual keyboard set as default, in operation S1380.

In the embodiment of FIGS. 13 and 14, the AR device 100 overlays and displays a virtual keyboard (e.g., the first keyboard 1410 in the embodiment shown in FIG. 14) on an area recognized based on the user's hand gesture input (e.g., the second area P₂ in the embodiment shown in FIG. 14). However, embodiments of the present disclosure are not limited thereto. According to an embodiment of the present disclosure, the AR device 100 may include at least one gaze tracking sensor, and may detect a gaze direction of both eyes of the user through the gaze tracking sensor, determine an area gazed by the user, based on a gaze point on which the detected gaze direction of both eyes converge, and overlay and display a virtual keyboard on the determined area.

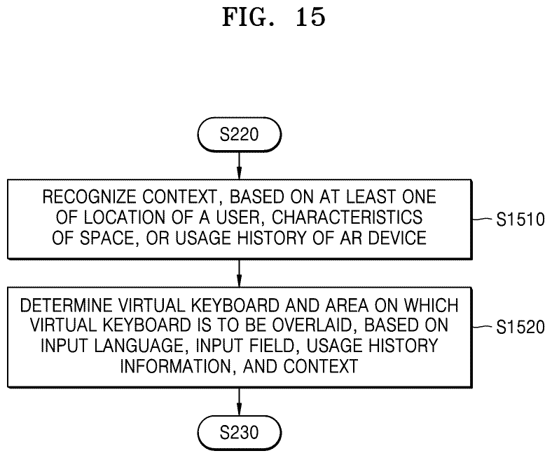

FIG. 15 is a flowchart of a method, performed by the AR device 100, of determining a virtual keyboard and an area on which the virtual keyboard is to be displayed, based on a context, according to an embodiment of the present disclosure.

Operations S1510 and S1520 of FIG. 15 are performed between operations S220 and S230 of FIG. 2. Operation S1510 of FIG. 15 may be performed after operation S220 of FIG. 2 is performed. Operation S1520 of FIG. 15 may be followed by operation S230 of FIG. 2.

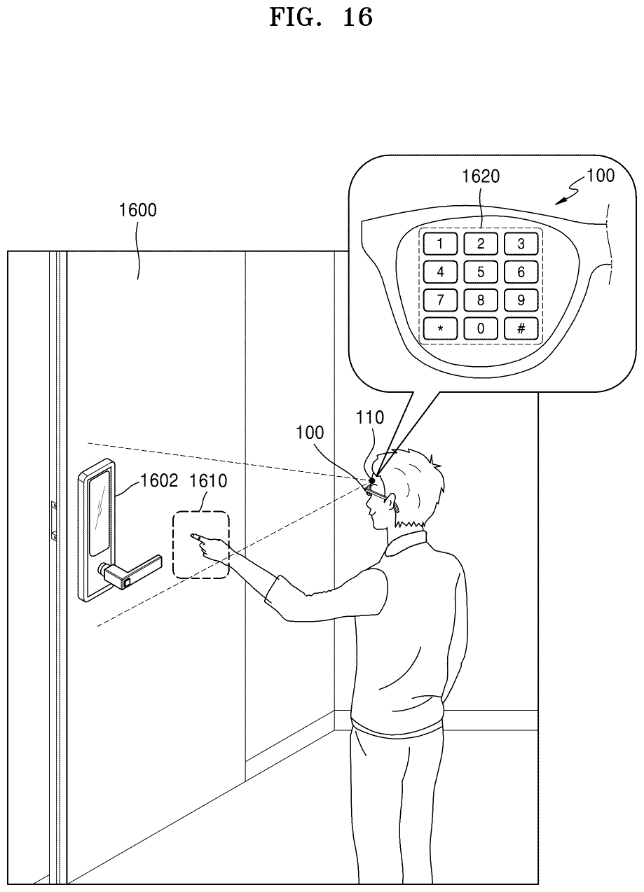

FIG. 16 is a view illustrating an operation of a method, performed by the AR device 100, of determining a virtual keyboard 1620 and an area 1610 on which the virtual keyboard 1620 is to be displayed, based on a context, according to an embodiment of the present disclosure.

Hereinafter, a function and/or operation of the AR device 100 will be described in detail with reference to FIGS. 15 and 16.

In operation S1510 of FIG. 15, the AR device 100 recognizes the context, based on at least one from among a location of a user, characteristics of a space, and usage history of the AR device 100. The AR device 100 may recognize the location and the characteristics of the space from an image obtained by photographing the surrounding's real world through the camera 110 (see FIG. 16). According to an embodiment of the present disclosure, the AR device 100 may include a position sensor such as a GPS sensor, and may obtain information about a current location of the user by using the position sensor. Referring to the embodiment of FIG. 16, the AR device 100 may obtain an image by photographing a front door 1600 through the camera 110, and the processor 130 (see FIG. 3) may recognize the front door 1600 and a door lock 1602 from the obtained image and may recognize characteristics of the user's location and space, based on the front door 1600 that is recognized and the door lock 1602 that is recognized. According to an embodiment of the present disclosure, the processor 130 may obtain history information indicating that the user has frequently used a virtual keyboard 1620 for entering a password in a situation where the front door 1600 and the door lock 1602 are recognized. In this case, the processor 130 may recognize a context of inputting the password for the door lock 1602, based on the user's current location (e.g., in front of the door), characteristics of the space (e.g., hallway in front of the door), and usage history information (e.g., password inputting).

Referring back to FIG. 15, in operation S1520, the AR device 100 determines a virtual keyboard and an area on which the virtual keyboard is to be overlaid, based on an input language, an input field, usage history information, and the context. Referring to the embodiment of FIG. 16, when the password for the door lock 1602 consists of numbers and thus the input language and the input field are numbers and history information indicating that the user has frequently used a numeric keypad is identified in the context from which the door lock 1602 is recognized, the processor 130 of the AR device 100 may determine the virtual keyboard 1620 of a numeric input method as the virtual keyboard that is to be overlaid, according to the context. For example, the processor 130 may display the virtual keyboard 1620, that is determined, of the numeric input method so that the virtual keyboard 1620, that is determined, is overlaid on the front door 1600. However, embodiments of the present disclosure are not limited thereto, and the processor 130 may overlay and display the virtual keyboard 1620 on the wall beside the front door 1600.

According to an embodiment of the present disclosure, a method, performed by the AR device 100, of displaying a virtual keyboard is provided. According to an embodiment of the present disclosure, the method may include operation S210 of detecting at least one area including a plane on which no objects are detected, by scanning a surrounding's real world. The method may include operation S220 of determining the type of virtual keyboard that is capable of being overlaid on the detected at least one area, based on at least one from among a shape, size, and input language of the virtual keyboard. The method may include operation S230 of performing rendering for overlaying and displaying the determined type of virtual keyboard on the at least one area.

According to an embodiment of the present disclosure, the operation S210 of detecting the at least one area may include obtaining 3D data about the real world by scanning a surrounding environment by using at least one from among the RGB camera, the infrared sensor 122, the depth camera 124, and the LiDAR sensor 126. The operation S210 of detecting the at least one area may include detecting, from the obtained 3D data, the at least one area including a surface having a plane on which the virtual keyboard is capable of being overlaid, by performing plane detection.

According to an embodiment of the present disclosure, the detecting of the at least one area may include detecting at least one area including a curved surface with a curvature from the obtained 3D data.

According to an embodiment of the present disclosure, profile information of the virtual keyboard including at least one from among shapes, sizes, and input languages of the virtual keyboards may be stored in the memory 140 of the AR device 100. The method may further include obtaining the profile information of the virtual keyboards by loading the profile information from the memory 140.

According to an embodiment of the present disclosure, the operation S220 of determining the type of virtual keyboard may include operation S610 of configuring area-virtual keyboard combinations by matching the at least one area with all types of virtual keyboards providable by the AR device 100. The operation S220 of determining the type of virtual keyboard may include operation S620 of evaluating the area-virtual keyboard combinations, based on area's attribute information including the size and shape of the at least one area and at least one from among the shape, size, and input language of virtual keyboards. The operation S220 of determining the type of virtual keyboard may include operation S630 of determining the type of virtual keyboard that is capable of being overlaid on the at least one area, based on a result of evaluating the area-virtual keyboard combinations.

According to an embodiment of the present disclosure, the operation S610 of configuring the area-virtual keyboard combinations may include matching a plurality of capable of being overlaid virtual keyboards to each of the at least one area.

According to an embodiment of the present disclosure, the virtual keyboard may include a split type keyboard. The operation S610 of configuring of the area-virtual keyboard combinations may include splitting the split type keyboard into a plurality of virtual keyboards and matching the plurality of virtual keyboards to a plurality of areas.

According to an embodiment of the present disclosure, the method may further include operation S640 of determining a virtual keyboard and an area on which the virtual keyboard is to be overlaid, from an area-virtual keyboard combination including the at least one area and the type of virtual keyboard capable of being overlaid, based on at least one from among an input language, an input field, and usage history information.

According to an embodiment of the present disclosure, the operation S210 of detecting the at least one area may include detecting a surface having a curvature of a portion of the user's body. The operation S230 of performing the rendering may include warping the determined virtual keyboard, based on the curvature of the surface.

According to an embodiment of the present disclosure, the method may further include, when the surface moves due to a movement of a body part of the user, tracking the movement and rotation of the surface by photographing the body part by using the camera 110. The operation S230 of performing the rendering may include rendering the virtual keyboard, based on moved location and rotation values of the surface obtained as a result of the tracking.

The operation S230 of performing the rendering may include obtaining color information of the determined area (S1210), and comparing the obtained color information with a color of the determined virtual keyboard (S1220). The operation S230 of performing the rendering may include changing a color of the entirety or a portion of the virtual keyboard, based on a result of the comparing (S1230).

According to an embodiment of the present disclosure, the method may further include recognizing a hand gesture of the user for displaying the virtual keyboard, by photographing the user's hand by using the camera 110 (S1310), and recognizing an area pointed by the user, based on the recognized hand gesture (S1320). The determining of the type of virtual keyboard (S220) may include determining the type of virtual keyboard capable of being overlaid on the recognized area from among the at least one area (S1340). The performing of the rendering (S230) may include rendering the determined virtual keyboard on the recognized area (S1370).

According to an embodiment of the present disclosure, the AR device 100 for displaying a virtual keyboard may be provided. The AR device 100 according to an embodiment of the present disclosure may include at least one camera 110, at least one sensor 120 including at least one from among an infrared sensor 122, a depth camera 124, and a LIDAR sensor 126, a memory 140 storing one or more instructions, and at least one processor 130 configured to execute the one or more instructions. The at least one processor 130 may detect at least one area including a plane on which no objects are detected, by scanning a surrounding's real world by using at least one from among the at least one camera 110 and the at least one sensor 120. The at least one processor 130 may determine the type of virtual keyboard that is capable of being overlaid on the detected at least one area, based on at least one from among a shape, size, and input language of the virtual keyboard. The at least one processor 130 may perform rendering for overlaying and displaying the determined type of virtual keyboard on the at least one area.

According to an embodiment of the present disclosure, The at least one processor 130 may obtain 3D data about the real world by scanning a surrounding environment by using at least one from among the at least one camera 110, the infrared sensor 122, the depth camera 124, and the LiDAR sensor 126. The at least one processor 130 may detect, from the 3D data, at least one area including a plane on which the virtual keyboard is capable of being overlaid by performing plane detection.

According to an embodiment of the present disclosure, the at least one processor 130 may detect at least one area including a curved surface with a curvature from the obtained 3D data.

According to an embodiment of the present disclosure, profile information of the virtual keyboard including at least one from among shapes, sizes, and input languages of the virtual keyboards may be stored in the memory 140. The at least one processor 130 may obtain the profile information of the virtual keyboards by loading the profile information from the memory 140.

According to an embodiment of the present disclosure, the at least one processor 130 may configure area-virtual keyboard combinations by matching the at least one area with all types of virtual keyboards providable by the AR device 100. The at least one processor 130 may evaluate the area-virtual keyboard combinations, based on area's attribute information including the size and shape of the at least one area and at least one from among the shape, size, and input language of virtual keyboards. The at least one processor 130 may determine the type of virtual keyboard that is capable of being overlaid on the at least one area, based on an evaluation result regarding the area-virtual keyboard combination.

According to an embodiment of the present disclosure, the virtual keyboard may include a split type keyboard. The at least one processor 130 may split the split type keyboard into a plurality of virtual keyboards and match the plurality of virtual keyboards to a plurality of areas.

According to an embodiment of the present disclosure, the at least one processor 130 may determine a virtual keyboard and an area on which the virtual keyboard is to be overlaid, from a combination of at least one area and a type of virtual keyboard, based on at least one from among an input language, an input field, and usage history information.

According to an embodiment of the present disclosure, the at least one processor 130 may detect a surface with a curvature of a portion of the user's body, and warp the determined virtual keyboard, based on the curvature of the surface.

According to an embodiment of the present disclosure, when the surface moves due to a movement of a body part of the user, the at least one processor 130 may track the movement and rotation of the surface from an image obtained by photographing the body part by using the camera 110. The at least one processor 130 may render the virtual keyboard, based on moved location and rotation values of the surface obtained as a result of the tracking.

According to an embodiment of the present disclosure, the at least one processor 130 may obtain color information of the determined area, and may compare the obtained color information with a color of the determined virtual keyboard. The at least one processor 130 may change a color of the entirety or a portion of the virtual keyboard, based on a result of the comparing.

According to an embodiment of the present disclosure, the at least one processor 130 may recognize a hand gesture of the user for displaying the virtual keyboard, by photographing the user's hand by using the camera 110, and may recognize an area pointed by the user, based on the recognized hand gesture. The at least one processor 130 may determine the type of virtual keyboard that is capable of being overlaid on the recognized area among the at least one area. The at least one processor 130 may render the determined type of virtual keyboard on the recognized area.

According to an embodiment of the present disclosure, a computer program product including a computer-readable storage medium is provided. The computer-readable storage medium may include instructions readable by the AR device 100 so that the AR device 100 performs the operations of detecting at least one area including a plane on which no objects are detected, by scanning a surrounding's real world; determining the type of virtual keyboard that is capable of being overlaid on the detected at least one area, based on at least one from among a shape, size, and input language of the virtual keyboard; and performing rendering for overlaying and displaying the determined type of virtual keyboard on the at least one area.

The program executed by the AR device 100 described above herein may be implemented as a hardware component, a software component, and/or a combination of hardware components and software components. The program may be executed by any system capable of executing computer readable instructions.

The software may include instructions (e.g., a computer program and/or code), and may constitute a processing device so that the processing device can operate as desired, or may independently or collectively instruction the processing device.

The software may be implemented as a computer program including instructions stored in computer-readable storage media. Examples of the computer-readable recording media include magnetic storage media (e.g., ROM, floppy disks, hard disks, etc.), and optical recording media (e.g., CD-ROMs, or digital versatile discs (DVDs)). The computer-readable recording media can be distributed over network coupled computer systems so that the computer-readable code is stored and executed in a distributive manner. These media can be read by the computer, stored in a memory, and executed by a processor.

The computer-readable storage medium may be provided as a non-transitory storage medium. Here, “non-transitory” means that the storage medium does not include a signal and is tangible, but does not distinguish a case where data is stored semi-permanently or temporarily in the storage medium. For example, the non-transitory storage media may include a buffer in which data is temporarily stored.

Programs according to various embodiments disclosed herein may be provided by being included in computer program products. The computer program product, which is a commodity, may be traded between sellers and buyers.

Computer program products may include a software program and a computer-readable storage medium having the software program stored thereon. For example, computer program products may include a product in the form of a software program (e.g., a downloadable application) that is electronically distributed through manufacturers of the AR device 100 or electronic markets (e.g., Samsung Galaxy Store™). For electronic distribution, at least a portion of the software program may be stored on a storage medium or may be created temporarily. In this case, the storage medium may be a server of a manufacturer of the AR device 100, a server of an electronic market, or a storage medium of a relay server for temporarily storing a software (SW) program.

The computer program product may include a storage medium of the server or a storage medium of the AR device 100, in a system composed of the AR device 100 and/or the server. Alternatively, if there is a third device (e.g., a wearable device) in communication with the AR device 100, the computer program product may include a storage medium of the third device. Alternatively, the computer program product may include the software program itself transmitted from the AR device 100 to the third device, or transmitted from the third device to the AR device 100.

In this case, one of the AR device 100 or the third device may execute the computer program product to perform the methods according to the disclosed embodiments. Alternatively, at least one from among the AR device 100 and the third device may execute the computer program product to distribute and perform the methods according to the disclosed embodiments.

For example, the AR device 100 may control another electronic device (e.g., a wearable device) in communication with the AR device 100 to perform the methods according to the disclosed embodiments, by executing the computer program product stored in the memory 140 of FIG. 3.

As another example, a third device may execute a computer program product to control an electronic device in communication with the third device to perform the methods according to the disclosed embodiments.

When the third device executes the computer program product, the third device may download the computer program product from the AR device 100 and execute the downloaded computer program product. Alternatively, the third device may execute a computer program product provided in a preloaded state to perform methods according to the disclosed embodiments.

While non-limiting example embodiments of present disclosure have been particularly shown and described with reference to the drawings, it will be understood by those of ordinary skill in the art that various changes in form and details may be made therein without departing from the spirit and scope of the present disclosure. For example, an appropriate result may be attained even when the above-described techniques are performed in a different order from the above-described method, and/or components, such as the above-described computer system or module, are coupled or combined in a different form from the above-described methods or substituted for or replaced by other components or equivalents thereof.

What is claimed is:

1. A method performed by an augmented reality (AR) device, the method comprising:
detecting, by scanning a surrounding real world, at least one area including a plane on which no objects are detected;
determining a type of a virtual keyboard capable of being overlaid on the at least one area, based on at least one from among a shape, a size, and an input language of the virtual keyboard; and
performing rendering such that the virtual keyboard, having the type, is overlaid and displayed on the at least one area.

2. The method of claim 1, wherein the detecting the at least one area comprises:
obtaining three-dimensional (3D) data about the surrounding real world by scanning a surrounding environment by using at least one from among an RGB camera, an infrared sensor, a depth camera, and a light detection and ranging (LiDAR) sensor; and
detecting, from the 3D data by performing plane detection, the at least one area, wherein the at least one area comprises a surface having the plane on which the virtual keyboard is capable of being overlaid.

3. The method of claim 1, further comprising obtaining profile information of virtual keyboards by loading the profile information from a memory,
wherein the profile information includes at least one from among shapes, sizes, and input languages of the virtual keyboards.

4. The method of claim 1, wherein the determining the type of the virtual keyboard comprises:
configuring area-virtual keyboard combinations by matching the at least one area with types of virtual keyboards providable by the AR device;
evaluating the area-virtual keyboard combinations based on attribute information of the at least one area, wherein the attribute information includes a size and a shape of the at least one area and at least one from among shapes, sizes, and input languages of the virtual keyboards; and
determining the type of the virtual keyboard capable of being overlaid on the at least one area based on a result of the evaluating the area-virtual keyboard combinations.

5. The method of claim 4, wherein the configuring the area-virtual keyboard combinations comprises matching a plurality of virtual keyboards that are capable of being overlaid to each of the at least one area.

6. The method of claim 4, further comprising determining the virtual keyboard, from among a plurality of virtual keyboards, and an area, from among the at least one area and on which the virtual keyboard is to be overlaid, from an area-virtual keyboard combination including the at least one area and the type of the virtual keyboard capable of being overlaid, based on at least one from among the input language, an input field, and usage history information of a user.

7. The method of claim 1, wherein
the detecting the at least one area comprises detecting a surface having a curvature of a portion of a body of a user, and
the performing the rendering comprises warping the virtual keyboard based on the curvature of the surface.

8. An augmented reality (AR) device, comprising:
at least one camera;
at least one sensor comprising at least one from among an infrared sensor, a depth camera, and a light detection and ranging (LiDAR) sensor;
a memory storing one or more instructions; and
at least one processor configured to execute the one or more instructions,
wherein the one or more instructions are configured to, when executed by the at least one processor, cause the AR device to:
detect, by scanning a surrounding real world by using at least one from among the at least one camera and the at least one sensor, at least one area comprising a plane on which no objects are detected;
determine a type of a virtual keyboard that is capable of being overlaid on the at least one area, based on at least one from among a shape, a size, and an input language of the virtual keyboard; and
perform rendering such that the virtual keyboard, having the type, is overlaid and displayed on the at least one area.

9. The AR device of claim 8, wherein the one or more instructions are further configured to, when executed by the at least one processor, cause the AR device to:
obtain three-dimensional (3D) data about the surrounding real world by scanning a surrounding environment by using at least one from among the at least one camera and the at least one sensor; and
detect, from the 3D data by performing plane detection, the at least one area, wherein the at least one area comprises a surface having the plane on which the virtual keyboard is capable of being overlaid.

10. The AR device of claim 9, wherein the at least one area that is detected comprises a curved surface with a curvature.

11. The AR device 100 of claim 8, wherein
the one or more instructions are further configured to, when executed by the at least one processor, cause the AR device to obtain profile information of virtual keyboards by loading the profile information from a memory, and
the profile information comprises at least one from among shapes, sizes, or input languages of virtual keyboards.

12. The AR device of claim 8, wherein the one or more instructions are further configured to, when executed by the at least one processor, cause the AR device to:
configure area-virtual keyboard combinations by matching the at least one area with types of virtual keyboards providable by the AR device;
evaluate the area-virtual keyboard combinations based on attribute information of the at least one area, wherein the attribute information includes a size and a shape of the at least one area and at least one from among shapes, sizes, and input languages of the virtual keyboards; and
determine the type of the virtual keyboard that is capable of being overlaid on the at least one area based on a result of evaluating the area-virtual keyboard combinations.

13. The AR device of claim 12, wherein the one or more instructions are further configured to, when executed by the at least one processor, cause the AR device to determine the virtual keyboard, from among a plurality of virtual keyboards, and an area, from among the at least one area and on which the virtual keyboard is to be overlaid, from an area-virtual keyboard combination comprising the at least one area and the type of the virtual keyboard capable of being overlaid, based on at least one from among the input language, an input field, and usage history information of a user.

14. The AR device of claim 8, wherein the one or more instructions are further configured to, when executed by the at least one processor, cause the AR device to detect a surface having a curvature of a portion of a body of a user, and warp the virtual keyboard based on the curvature of the surface.

15. A computer program product comprising a non-transitory computer-readable storage medium, the non-transitory computer-readable storage medium comprising instructions that are configured to, when executed by at least one processor of an augmented reality (AR) device, cause the AR device to:
detect, by scanning a surrounding real world, at least one area comprising a plane on which no objects are detected;
determine a type of a virtual keyboard that is capable of being overlaid on the at least one area, based on at least one from among a shape, a size, or an input language of the virtual keyboard; and
perform rendering such that the virtual keyboard, having the type, is overlaid and displayed on the at least one area.
